(19) United States
(12) Patent Application Publication
(10) Pub. No.: US 2016/0378932 A1
(43) Pub. Date: Dec. 29, 2016

(54) DASHBOARD INTERFACE, SYSTEM AND ENVIRONMENT FOR SUBSCRIPTION PRODUCT EXCHANGE, MANAGEMENT, AND ANALYSIS

(71) Applicant: AON GLOBAL OPERATIONS LIMITED (SINGAPORE BRANCH) (REG. T12FC0122F), Singapore (SG)

(72) Inventors: Kenneth L. SPERLING, Orange, CT (US); Karen F. Frost, Lakemoor, IL (US); Steven W. Clark, Grayslake, IL (US); David Mallett, Colchester, CT (US); Tim Maroz, Melbourme, FL (US); David T. Petta, Papillion, NE (US); Justin M. Kindy, Greenwood Village, CO (US); Timothy N. Nimmer, Castle Rock, CO (US); Jordan L. Simmermaker, Mundelein, IL (US)

(73) Assignee: AON GLOBAL OPERATIONS LIMITED (SINGAPORE BRANCH) (REG. T12FC0122F), Singapore (SG)

(21) Appl. No.: 15/258,456

(22) Filed: Sep. 7, 2016

Related U.S. Application Data
(63) Continuation-in-part of application No. 14/283,806, filed on May 21, 2014, now abandoned.

(51) Int. Cl. G06F 19/00; G06Q 40/08

(52) U.S. Cl. CPC G06F 19/328; G06Q 40/08; G06F 19/322; G06F 3/04847

(57) ABSTRACT

In a preferred embodiment, a system of graphical user interfaces for real-time display of data views includes a user dashboard including a summary control for presenting current subscription plan coverage, and a compare control for presenting comparison information comparing the current subscription plan coverage to additional plans; an employer dashboard including a summary control for presenting summary information identifying subscription plan offerings extended to employees, and a compare control for presenting the employer with comparison information comparing the plan offerings extended to the employees to plan offerings extended by other employers; and a carrier dashboard including an enrollment control for presenting information identifying enrollment metrics of subscribers, and a ratings control for presenting comparison information comparing at least one ratings metric corresponding to ratings submitted by subscribers of the carrier to respective peer ratings metrics corresponding to ratings submitted by subscribers of peer carriers.

### CROSS REFERENCES TO RELATED APPLICATIONS

This application is a continuation-in-part of U.S. application Ser. No. 14/283,806, filed May 21, 2014, the contents of which are incorporated by reference in their entirety. This application is also related to U.S. application Ser. No. 14/635,956 filed Mar. 2, 2015, the contents of which are incorporated by referents in their entirety.

### BACKGROUND

Digital dashboards are graphical information layouts providing a user access to a snapshot of present information. Digital dashboards have been used extensively within the information technology industry to track trends and status of information networks. More recently, the use of digital dashboards has been extended to provide information regarding work flows and status updates regarding other processes, such as manufacturing facility performance dashboards, security system dashboards, and customer relationship management dashboards. Digital dashboards are composed of a number of elements, similar to the dashboard of an automobile. Various graphical illustrations, for example, can provide a user with a status reading or a graphical trend over a period of time. The graphical elements of the dashboard may be designed as individual dashboard widgets or software algorithms. In this manner, dashboard elements may be added and/or removed as desired by the designer and/or user.

The cost to employers of providing health care insurance for their employees has been increasing steadily for years. The Patient Protection and Affordable Care Act (PPACA), which was signed into law by President Obama in 2010, is an attempt to control those costs while providing health care insurance for a large number of Americans that otherwise would not have such insurance. Among other things, the PPACA allows for the creation of state-run insurance exchanges for individuals and small businesses to purchase coverage. Such exchanges will be designed to diversify the risk presented to potential insurance carriers, provide a larger set of subscribers, and improve the bargaining position of the businesses participating in the exchange vis-à-vis the insurance carriers. Under the PPACA, however, not all Americans will be eligible to participate in the state exchanges.

Private insurance exchanges are being established with the goal of providing at least a portion of the benefits envisioned by the state-run insurance exchanges. Through a private exchange, insurance carriers are connected to employers to offer subsidized health insurance plans to employees and retirees. A private insurance exchange system is described in U.S. patent application Ser. No. 13/231,601, entitled “Risk Adjusted Insurance Exchange with Sustainable Premiums” and filed Sep. 13, 2011, incorporated herein by reference in its entirety.

### SUMMARY OF ILLUSTRATIVE EMBODIMENTS

A subscription product exchange system and environment, as described herein, connects carriers to employers and/or individuals to support the selection and management of subscription products, such as insurance plans, and associated transactions such as insurance claims. Dashboard interfaces presented to the carriers, employers and individuals provide the viewer with up-to-date information regarding their subscription products (policies, plans, etc.) as well as comparison metrics. For example, a subscriber dashboard presents a subscriber with plan information, ratings information associated with subscribed plans, and risk score comparisons providing the subscriber with an assessment of individual health risks and a comparison of the individual health risks to demographic averages. An employer dashboard presents much of the same information as the subscriber dashboard, but in aggregate form. For example, the employer dashboard presents information on plans subscribed to by employees, ratings of the subscribed plans, and aggregate risk score data regarding common employee base health risks. Additionally, the employer dashboard presents comparisons between the employer and selected additional employers (e.g., competitors or peers of the employer), such as a comparison of the employer's benefits portfolio to portfolios offered by competitors and a comparison of the health risks of the employee base of the employer to the health risks of the employee bases of competitors. A carrier dashboard, for example, presents a carrier with product information, subscription metrics (e.g., subscriptions, declined offers, and offers receiving no response), claims metrics (e.g., premiums, costs, and/or profits), subscriber risk and market demographic metrics, and comparisons of these metrics to the metrics of competitors. The metrics can be indexed by geographical regions, employment sectors, and/or demographic classifications of the subscribers.

The insurance exchange system and environment, in some implementations, increases cost transparency by allowing individuals to compare the costs and benefits of various plans offered either directly by carriers or via employer selected plans. Employers may further enable employees to control costs by designating a defined contribution towards health insurance. The employee, through defined contribution, has the option to select a plan within the defined contribution budget or a costlier plan requiring an employee contribution in addition to the employer-provided subsidy.

In some implementations, the insurance exchange system and environment further enhances the insurance plan selection experience for employers and/or individuals by allowing employers and/or subscribers to rate the insurance carriers and the individual plans offered through the system. The insurance exchange system and environment may include ratings information (e.g., in plan comparison user interfaces) to allow employers and/or individuals to select those carriers or plans best suited to their needs, including those recognized for excellence by present subscribers and/or employers. In addition to ratings, the insurance exchange system and environment may collect reviews submitted by employers and/or subscribers. To best address the needs of a variety of employers and/or individuals, the insurance exchange system and environment may filter ratings or reviews to highlight those provided by employers/subscribers similar to the reviewing employer/subscriber. For example, the insurance exchange system and environment may filter by demographic and/or medical history information to identify subscribers most similar to a current individual.

Rather than selecting a new insurance plan, in some implementations, the health insurance exchange and environment provides a subscriber the opportunity to port a current insurance plan from a former employer to a present employer. In this manner, the subscriber maintains present coverage during a career change.

In some implementations, the insurance exchange system and environment communicates with a third party medical history record repository to access medical history records on behalf of subscribers. With subscriber authorization, for example, the insurance exchange system and environment retrieves medical history records and combines the medical history record information with claims information, demographics information, and other information maintained by the insurance exchange system and environment. Through a subscriber dashboard, for example, the subscriber may review combined health data. Furthermore, the insurance exchange system and environment may analyze the medical history records to present value-added statistical information to the subscriber, such as tracking health metrics (e.g., weight, cholesterol levels, blood pressure, etc.) graphically over time and recommending changes in behavior to mitigate identified areas of increased risk.

The insurance exchange system and environment, in some implementations, calculates statistical information regarding the various entities (insurance carriers, employers, and/or subscribers) involved in the insurance exchange system. For example, the insurance exchange system and environment may derive pricing statistics, cost statistics, and/or efficiency statistics regarding the various insurance carriers. In another example, the insurance exchange system and environment may track site usage of a web site, web portal, or network-enabled dashboard system to identify site usage statistics. In this manner, the insurance exchange system and environment may make improvements to the employer interface, carrier interface, and/or subscriber interface to increase value for each of the entities involved in the exchange system. In a third example, the insurance exchange system and environment may analyze claims data and/or prescription data to monitor usage of various plan features and/or to monitor premium payouts relative to plan subsidies paid.

In some implementations, in addition to health insurance, life insurance, and disability insurance plans, the health insurance exchange system and environment connects voluntary products carriers with employers (to enhance benefits offerings) and/or individual subscribers (to round out household coverage based upon individual needs). The voluntary products, for example, may include dental insurance, vision insurance, additional life/disability insurance, and/or pet insurance. The system may collect ratings, reviews, and/or statistics regarding the voluntary products in a similar manner as to the insurance plans.

In one aspect, the present description relates to a method for presenting information to an individual in a dashboard on behalf of an insurance exchange including retrieving from a user profile, by a server, demographic information regarding the individual, retrieving, from one or more clients, medical history data associated with the individual, and identifying, at the server, within the medical history data, a number of health metrics, where the number of health metrics include one or more of weight, BMI, pulse rate, and blood pressure. The method may include calculating, at the server, and based at least in part upon the demographic information and the health metrics, a risk score associated with the individual, preparing, at the server, and for presentation upon a subscriber computing system controlled by the individual, display instructions which, when executed by the subscriber computing system, render the risk score upon a display device of the subscriber computing system within the dashboard, and providing, to the subscriber computing system, the display instructions.

In some embodiments, the medical history data is retrieved responsive to receiving, at the server, authorization from the individual to access the medical history data. The method may include identifying, at the server, and based upon the risk score calculation, one or more primary factors affecting the risk score of the individual, where at least one of the one or more primary factors is a first health metric of the number of health metrics. Preparing the display instructions may include preparing the display instructions to render the one or more primary risk factors upon the display device. The method may include identifying, at the server, and based upon the demographic information, at least one average risk score for subscribers with a similar demographic profile to the individual, where the similar demographic profile includes one or more of age, gender, and race. Preparing the display instructions may include preparing the display instructions to render the at least one average risk score upon the display device.

In some embodiments, the method includes identifying, at the server, and based upon the demographic information, at least one average health metric for subscribers with a similar demographic profile to the individual, where the similar demographic profile includes one or more of age, gender, and race. Preparing the display instructions may include preparing the display instructions to render the at least one average health metric upon the display device. The method may include receiving, at the server, authorization from the individual to access medical history data, de-identifying, at the server, the medical history data, and storing, in a shared storage region accessible to a carrier computing system, the de-identified medical history data.

In one aspect, the present disclosure describes an insurance exchange system including a server having a processor, a network interface for sending and receiving data via a network, and a non-transitory computer storage medium coupled to the processor. The system may include a number of carrier computing devices coupled to the server via the network, where the number of carrier computing devices are operated by a number of insurance carriers. The system may include a number of subscriber computing devices coupled to the server via the network, where the number of subscriber computing devices are operated by a number of subscribers. The processor may be configured to receive, from a first subscriber computing device operated by a first subscriber, a request for insurance plan information, access a user profile associated with the first subscriber, and identify, from the user profile, an insurance plan associated with a first carrier of the number of carriers, where the first subscriber is subscribed to the insurance plan. The processor may be configured to calculate, based upon a number of ratings submitted by a subset of the number of subscribers, a carrier rating associated with the first carrier. The processor may be configured to prepare, for presentation upon the first subscriber computing device, display instructions which, when executed by the first subscriber computing device, render the carrier rating and information regarding the insurance plan upon a display device of the first subscriber computing device, and provide, to the first subscriber computing device, the display instructions.

In some embodiments, the system includes a number of employer computing devices coupled to the server via the network, where the number of employer computing devices are operated by a number of employers. The processor may be configured to identify, from the user profile, a first employer of the number of employers, and identify, based upon the first employer, one or more additional insurance plans offered through the first employer, where preparing the display instructions includes preparing display instructions which, when executed, render, for each additional insurance plan, information regarding the additional insurance plan. At least one additional insurance plan of the one or more additional insurance plans may be provided by a carrier different than the first carrier. The processor may be configured to calculate, based upon the number of ratings, a respective carrier rating associated with each additional carrier. Preparing the display instructions may include preparing display instructions which, when executed, render the information regarding the additional insurance plans arranged in order by user rating.

In some embodiments, the system includes a number of employer computing devices coupled to the server via the network, where the number of employer computing devices are operated by a number of employers. The processor may be configured to identify a defined contribution provided by the first employer for the first subscriber to purchase the insurance plan. Preparing the display instructions may include preparing display instructions which, when executed, render the defined contribution and a subscriber contribution paid towards the insurance plan. The information regarding the insurance plan may include a summary of current insurance plan coverage as subscribed by the first subscriber. The insurance plan may be a health insurance plan.

In one aspect, the present disclosure describes a non-transitory computer readable medium having instructions stored thereon, where the instructions, when executed by a processor, cause the processor to access demographic information associated with each employee of a number of employees of an employer, calculate, based at least in part upon the demographic information, a group risk score representing an average risk of the number of employees, and identify, based upon the group risk score calculation, one or more primary factors affecting the group, where at least one of the one or more primary factors is a first health metric of a number of health metrics including weight, BMI, pulse rate, and blood pressure. The instructions, when executed, may cause the processor to prepare, for presentation upon an employer computing system controlled by the employer, display instructions which, when executed by the employer computing system, render the group risk score and the one or more primary factors upon a display device of the employer computing system, and provide, to the employer computing system, the display instructions.

In some embodiments, the instructions, when executed, cause the processor to access demographic information associated with the employer, where the demographic information includes one or more of address, geographic region, employment sector, number of employees, size, incorporation date, and age, and identify a number of peers of the employer, where each peer of the number of peers shares one or more similarities with the demographic information of the employer. The instructions, when executed, may cause the processor to identify, for each peer of the number of peers, a respective group risk score. Preparing the display instructions may include preparing display instructions which, when executed by the employer computing system, render a comparison of the group risk score and the respective group risk scores of the number of peers upon the display device of the employer computing system. Preparing the display instructions to render the comparison of the group risk score may include identifying each peer of the number of peers anonymously.

In some embodiments, the instructions, when executed, cause the processor to receive authorization, on behalf of one or more subscribers of a health exchange system, to access respective medical history data belonging to each subscriber, where the one or more subscribers include at least a portion of a number of employees of the employer. The instructions, when executed, may cause the processor to retrieve, from a third party server system, medical history data associated with each subscriber of the one or more subscribers, identify, within the medical history data associated with each subscriber of the one or more subscribers, one or more health metrics, and calculate, based upon the medical history data, one or more aggregate health metrics. Calculating the group risk score may include calculating the group risk score based further in part upon at least one of the one or more aggregate health metrics.

In some embodiments, the instructions, when executed, cause the processor to anonymize the medical history data associated with each subscriber of the one or more subscribers. The instructions, when executed, may cause the processor to identify, for each peer of the number of peers, one or more peer aggregate health metrics. Preparing the display instructions may include preparing display instructions which, when executed by the employer computing system, render a comparison of at least a first aggregate health metric of the one or more aggregate health metrics and the respective aggregate peer health metric of the number of peers corresponding to the first aggregate health metric upon the display device of the employer computing system.

In some embodiments, the instructions, when executed, cause the processor to calculate, based upon the demographic information, one or more aggregate demographic metrics, where the one or more aggregate demographic metrics include an aggregate age statistic representing an average or mean age of the number of employees, an aggregate gender statistic representing an employee base gender composition, and an aggregate race statistic representing an employee base race composition. Preparing the display instructions may include preparing display instructions which, when executed by the employer computing system, render at least one of a) a graphical representation of the aggregate gender statistic, b) a graphical representation of the aggregate race statistic, and c) a graphical representation of the aggregate age statistic upon the display device of the employer computing system. The instructions, when executed, may cause the processor to identify, for each peer of the number of peers, one or more peer aggregate demographic metrics, where the peer aggregate demographic metrics include an aggregate age statistic and an aggregate gender statistic. Preparing the display instructions may include preparing display instructions which, when executed by the employer computing system, render a comparison of at least a first aggregate demographic metric of the one or more aggregate demographic metrics and the respective aggregate peer demographic metric of the number of peers corresponding to the first aggregate demographic metric upon the display device of the employer computing system.

### BRIEF DESCRIPTION OF THE DRAWINGS

FIG. 1 is a screen shot of an example individual subscriber dashboard user interface for accessing subscriber information via a subscription product exchange system;

FIG. 2 is a screen shot of an example employer dashboard user interface for accessing employer information via a subscription product exchange system;

FIG. 3 is a screen shot of an example exchange dashboard user interface for accessing information about a subscription product exchange system;

FIGS. 4A through 4C illustrate screen shots of example carrier dashboard user interfaces for accessing carrier information via a subscription product exchange system;

FIGS. 5A and 5B are block diagrams of example environments for managing the exchange of subscription products between carriers and subscribers;

FIGS. 6A and 6B illustrate a swim lane diagram of an example method for porting an insurance plan established via a prior employer to a present employer;

FIGS. 7A and 7B illustrate a flow chart of an example method for presenting a potential subscriber with plan and voluntary product information based in part on ratings data;

FIG. 8 is a block diagram of an example environment for personalizing the subscription product exchange system experience for both employers and subscribers;

FIG. 9 is a block diagram of an example computing system; and

FIG. 10 is a block diagram of an example distributing computing environment including a cloud computing environment.

### DETAILED DESCRIPTION OF ILLUSTRATIVE EMBODIMENTS

In some implementations, entities (carriers, employers, subscribers, and exchange managers) interact with an insurance exchange system and environment via graphical user interface dashboards. Each dashboard includes a number of controls configured, upon selection, to present the entity (carrier, subscriber, employer, or exchange manager) with information relevant to the type of entity. The controls presented to a particular entity may be configurable based upon a user profile. For example, a subscriber may select various features (widgets, controls, and/or other information displays) to include within a personalized dashboard. In another example, features provided within the dashboard may be designated in part upon a user authorization level. For example, a human resources representative employed by an employer may have access to a limited view of benefits metrics, while a CEO or board member may have unlimited access to benefits metrics.

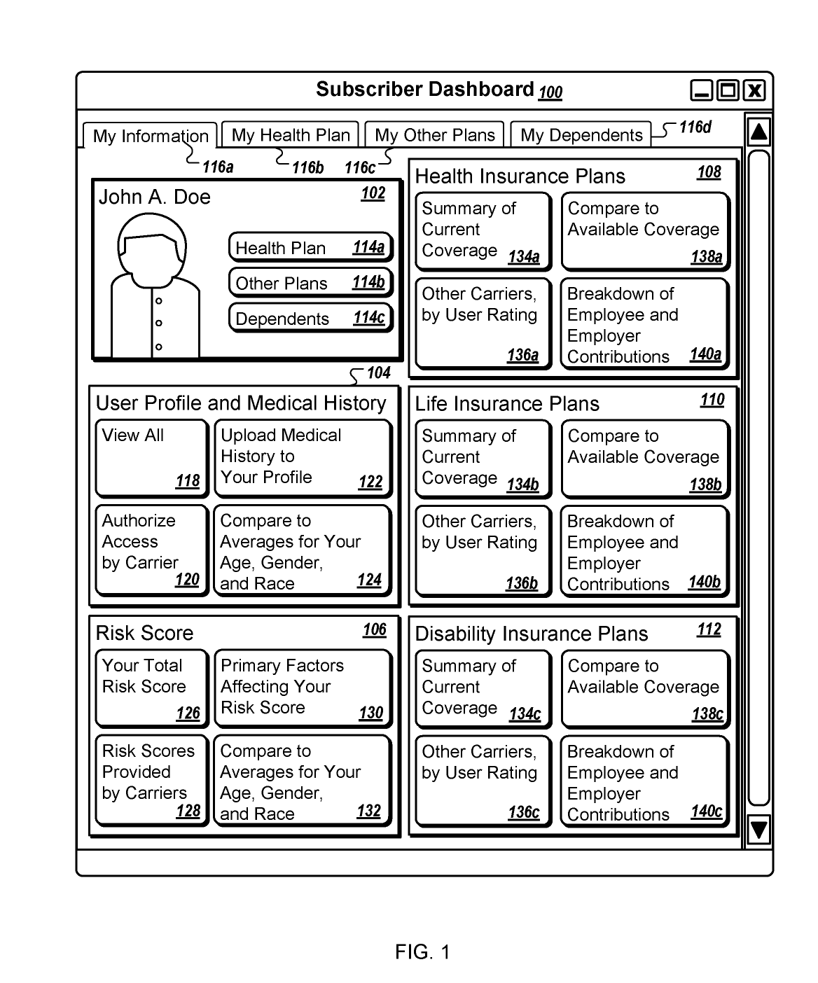

Beginning with the subscribers, FIG. 1 is a screen shot of an example individual subscriber dashboard 100 for accessing subscriber information via an insurance exchange system. The dashboard 100 is part of a web site, web portal, personal computer application, or mobile device application configured to allow the subscriber to interface with the insurance exchange system and environment. As illustrated, subscriber “John A. Doe” is connected to the dashboard 100.

In a welcome pane 102, subscriber Doe is presented with three navigation controls 114, correlating to three additional tabs 116 at the top of the dashboard 100. A first navigation control 114a, when selected, presents subscriber Doe with detailed information regarding his health plan within a “my health plan” tab 116b. A second navigation control 114b, when selected, presents subscriber Doe with detailed information regarding other plans subscribed to by subscriber Doe (e.g., life insurance, disability insurance, etc.) within a “my other plans” tab 116c. A third navigation control 114c, when selected, presents subscriber Doe with information regarding his dependents within a “my dependents” tab 116d.

In a present “my information” tab 116a, the dashboard 100 provides a number of selectable controls to subscriber Doe, organized within a series of information panes 104, 106, 108, 110, and 112. In the first information pane 104, the dashboard 100 provides information regarding subscriber Doe's user profile and medical history. In some implementations, a “view all” control 118, when selected, presents subscriber Doe with personal information, including profile information (e.g., name, address, phone number, email address, etc.) and demographic information (e.g., age or birth date, gender, race, etc.). The medical history information presented by the “view all” control 118, for example, may include information regarding insurance claims filed via the insurance exchange system and environment. If subscriber Doe uploaded external medical history records, the “view all” control 118 may provide subscriber Doe with a comprehensive review of medical history records.

If subscriber Doe wishes to link electronic medical records to the dashboard 100, in some implementations, subscriber Doe selects an “upload medical history to your profile” control 122. The control 122, upon selection, may provide a connection between the insurance exchange system and a third party electronic medical record repository. Upon authorization and validation of subscriber John Doe, for example, subscriber Doe's electronic medical records (or a portion thereof) may be accessed via the insurance exchange system. In this manner, in some examples, the insurance exchange system can help subscriber Doe to identify dates of recent doctor visits or determine when subscriber Doe was last vaccinated for tetanus. With access to subscriber Doe's medical history, the insurance exchange system may automatically populate prescription information, medical diagnoses, health conditions, and/or health metric data into subscriber Doe's user profile. Furthermore, upon selection of the “view all” control 118, the health exchange system and environment may now provide subscriber Doe with the ability to track medical trends or behaviors such as increase in weight over time or decrease in blood pressure over time.

After linking electronic medical records to the insurance exchange system and environment, in some implementations, subscriber Doe can choose to authorize access the medical history data by one or more insurance carriers. By selecting an “authorize access by carrier” control 120, for example, subscriber Doe may authorize the insurance exchange system to share medical history information with one or more carriers, such as the carriers associated with subscriber Doe's health insurance plan (e.g., described in relation to information pane 108), life insurance plan (e.g., described in relation to information pane 110), and/or disability insurance plan (e.g., described in relation to information pane 112). The insurance exchange system, for example, may share subscriber medical history, upon authorization, as de-identified data. In this manner, the insurance carriers may access information regarding individuals within the insurance exchange system and environment without raising privacy concerns. The de-identification process, for example, may be based upon governmental guidelines, such as the U.S. Health Insurance Portability and Accountability Act (HIPAA) guidelines of 1996.

In some implementations, subscriber Doe may select a “compare to averages for your age, gender, and race” control 124 to view a comparison between information contained in the user profile and/or user medical records and baseline numbers of a demographically similar population. The baseline numbers, for example, may represent average and/or median values determined from data provided by other individuals participating in the insurance exchange system and environment. The baseline data, in another example, may include data provided by a government or medical affiliation source, such as information collected by the National Institute of Health. Upon selection of the “compare to averages for your age, gender, and race” control 124, for example, subscriber Doe may be presented with graphical illustrations of where particular health metrics (e.g., weight, blood pressure, cholesterol level, etc.) land in relation to present norms and/or goal values. For example, subscriber Doe may have a statistically average body mass index and a significantly lower than average blood pressure.

Turning to the risk score information pane 106, a “your total risk score” control 126, upon selection, presents subscriber Doe with information regarding his insurance risk score. The risk score information, in some examples, may include the raw score as well as, optionally, individual factors contributing to the score. Alternatively, rather than presenting the information upon selection of the “your total risk score” control 126, the risk score pane 106 may present a total risk score value, while additional controls within the risk score pane 106 may present details underlying the composition of subscriber Doe's total risk score.

In some implementations, subscriber Doe selects a “primary factors affecting your risk score” control 130 to learn about the composition of the risk score. For example, a number of factors may contribute to a risk score computation model such as, in some examples, age, gender, race, geographic region, and medical claims history. The primary factors may include factors under the control of subscriber Doe such as, in some examples, smoking status, weight, and/or blood pressure. The “primary factors affecting your risk score” control 130 may present the risk score factors to subscriber Doe, upon selection, to encourage subscriber Doe to make improvements in the total risk score. Furthermore, in some implementations, the dashboard 100 presents subscriber Doe with recommendations for assistance in managing goals in reducing overall risk score, such as an invitation to join a smoking cessation program, an advertisement regarding a weight loss medication, or a reminder regarding a gym membership benefit feature of subscriber Doe's medical plan.

Subscriber Doe, in some implementations, selects a “compare to averages for your age, gender, and race” control 132 to compare his risk score to other subscribers (or established baseline averages) among those with a similar demographic background. In this manner, subscriber Doe may compare his relative risk to those sharing demographic information with him.

If subscriber Doe has one or more dependents (e.g., spouse, partner, and/or children) subscribed to the health insurance plan, in some implementations, selection of the your total risk score control 126 provides information regarding risk scores applied to each member of subscriber Doe's subscription. Similarly, subscriber Doe's wife, partner, and/or children may be provided the opportunity to review average comparisons by selecting the “compare to averages for your age, gender, and race” control 132 as well as primary factors affecting each individual's risk score through selection of the “primary factors affecting your risk score” control 130. Furthermore, in some implementations, each of the controls may provide information regarding primary factors and averages based upon the unit as a whole (e.g., as compared to other married couples in their thirties, as compared to other parents of multiple grade school children, etc.).

In some implementations, subscriber Doe selects a “risk scores provided by carriers” control 128 to identify risk score applied by one or more carriers (e.g., the carrier of Doe's health insurance plan, the carrier of subscriber Doe's life insurance plan, etc.). The insurance carriers, for example, may each use internal algorithms for determining risk score. Additionally, should subscriber Doe have an out-of-network plan, such as a state exchange plan, federal exchange plan or other private or group coverage obtained outside of the exchange system and environment, selection of the risk scores provided by carriers control 128 may cause presentation of the risk score calculated by the out-of-network plan. The factors contributing to risk scores generated by insurance carriers may or may not be known. For example, the insurance carrier may optionally volunteer information regarding factors which contribute to risk score determinations.

The three remaining information panes 108, 110, and 112 share identical controls, each set of controls providing information related to the various insurance plans subscribed to by subscriber Doe. As such, the health insurance plan pane 108, the life insurance plan pane 110, and the disability insurance plan pane 112 are described in general as containing insurance plan controls 134, 136, 138, and 140. However, the information presented will differ, upon selection of the insurance plan controls 134, 136, 138, and 140, based upon the type of insurance plan being reviewed by subscriber Doe.

A “summary of current coverage” control 134, when selected, presents subscriber Doe with summary information regarding his insurance plan coverage. The summary information, in the example of a health insurance plan, may include co-pay information, network providers, deductible information, and other health plan features. Similarly, the summary information, in the example of a life insurance plan, may include term, rate, death benefit, accidental death benefit, and present value.

To compare the present coverage with other available plans, in some implementations, subscriber Doe selects a “compare to available coverage” control 138. Upon selection of the “compare to available coverage” control 138a, the individual dashboard may present subscriber Doe with information regarding other plans available through the insurance exchange system. In the example of disability insurance, the dashboard may present a comparison of premiums and benefit values of similar products to subscriber Doe's current disability insurance. In another example, upon selection of the “compare to available coverage” control 138b, subscriber Doe may be provided with a browser interface to select one or more other available plans for comparison. If subscriber Doe's employer has selected particular plans as employee options, the “compare to available coverage” control 138 may limit the plans available for subscriber Doe's review to only those plans selected by the employer.

In some implementations, subscriber Doe selects an “other carriers by user rating” control 136 to review insurance plans offered by the highest rated insurance carriers within the insurance exchange system. The ratings, for example, may be based upon a sliding scale, number of stars, or other rating mechanism demonstrating a level of satisfaction a particular subscriber or employer has with a particular carrier or insurance plan. In one example, various aspects of a plan and/or insurance carrier may be rated separately. For example, the ratings and insurance exchange system may maintain separate subscriber customer service ratings, employer customer service ratings, subscriber billing ratings, and employer billing ratings for each carrier. The insurance exchange system, in another example, may maintain separate provider network ratings, plan feature ratings, and economic value ratings associated with each health plan offered by a particular carrier. For example, upon selection of the “other carriers by user rating” control 136, the dashboard may present subscriber Doe with available plans (or alternate carriers) corresponding to the top three carriers by ratings submitted by subscribers (and/or employers). If subscriber Doe's employer has selected particular plans as employee options, the “other carriers by user rating” control 136 may limit the plans or carriers available for subscriber Doe's review to only those plans selected by the employer.

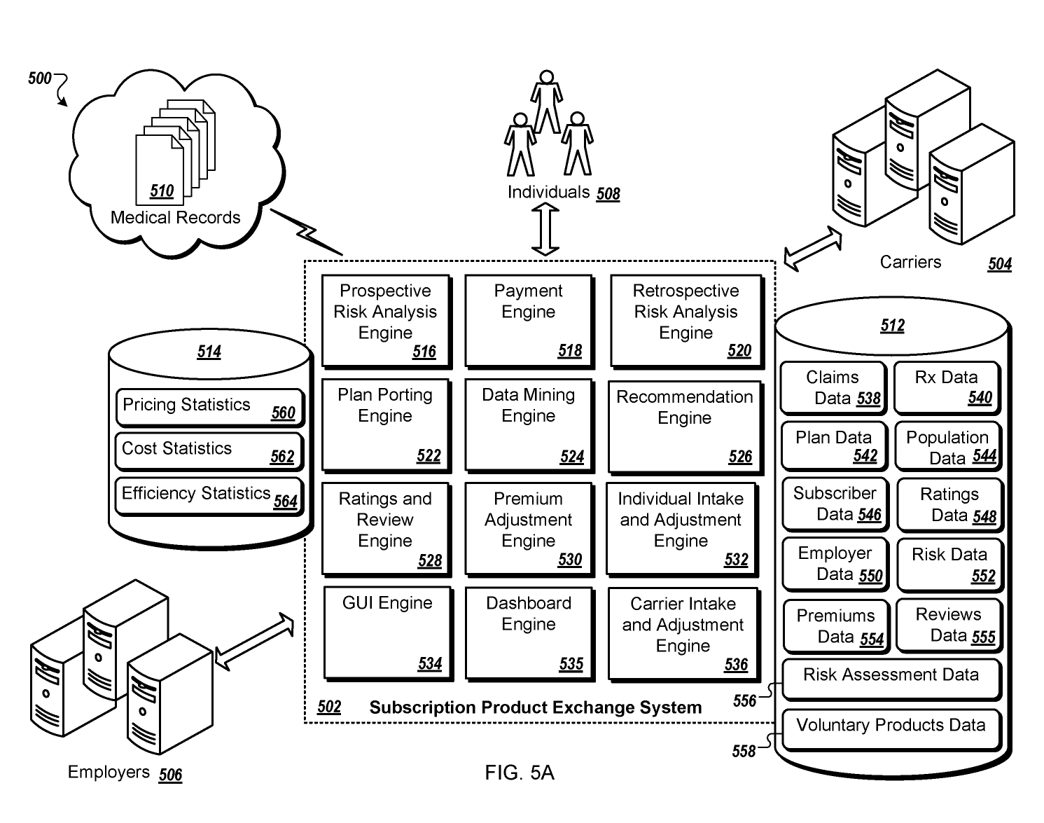

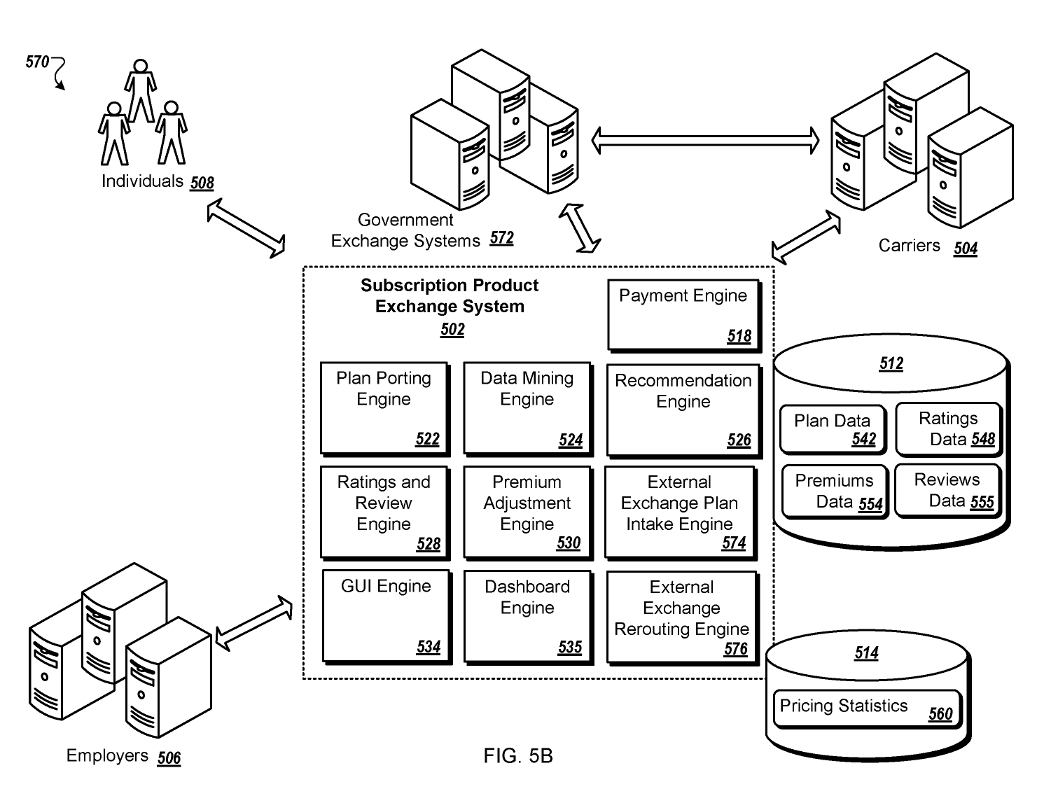

Instead of or in addition to presenting additional carriers available through the health care exchange, selection of the “other carriers, by user rating” control 136a presents subscriber Doe with information regarding plans or carriers available through one or more government-run insurance exchange systems, such as a federal health care exchange or a state health care exchange. Carriers, for example, may sign up with the insurance exchange system to allow the insurance exchange system to act as the state exchange broker or federal exchange broker. Interaction between the insurance exchange environment and state and/or federal insurance exchanges is described in greater detail in relation to FIG. 5B.

In some implementations, if subscriber Doe is an individual participating independently in the insurance exchange system and environment, or if subscriber Doe has been provided an employer contribution for selection of insurance coverage, the “other carriers by user rating” control 136 provides subscriber Doe the opportunity to request an insurance quote from an alternate carrier. In this manner, subscriber Doe can shop around for quotes. Conversely, since subscriber Doe's demographic information and risk score is already known by the insurance exchange system, a customized quote may be automatically provided in relation to the additional carriers.

A “breakdown of employee and employer contributions” control 140, presents, upon selection by subscriber Doe, information regarding the employer payment towards the insurance plan and the remaining premium covered by subscriber Doe. If the employer has provided a defined contribution, the “breakdown of employee and employer contributions” control 140 may compare the defined contribution to the actual cost of the plan.

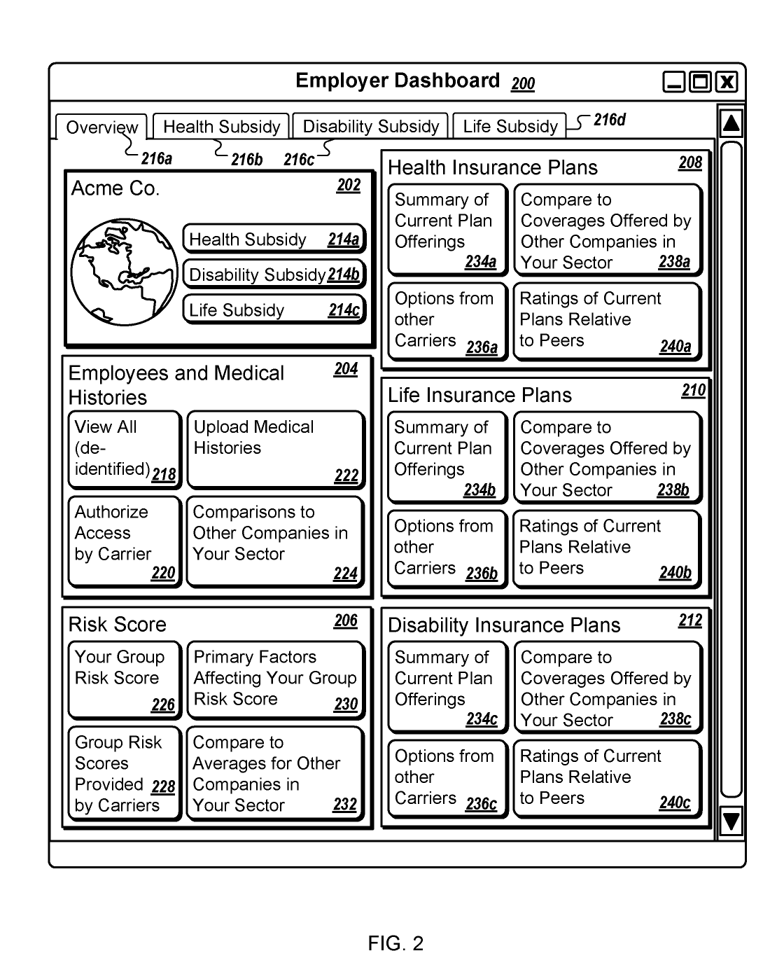

FIG. 2 is a screen shot of an example employer dashboard user interface 200 for accessing employer information via an insurance exchange system. The dashboard 200 is part of a web site, web portal, personal computer application, or mobile device application configured to allow the employer (e.g., benefits manager, human resource personnel, board member, or other corporate official) to interface with the insurance exchange system and environment. As illustrated, employer “Acme Co.” is connected to the dashboard 200.

In a welcome pane 202, employer Acme is presented with three navigation controls 214, correlating to three additional tabs 216 at the top of the dashboard 200. A first navigation control 214a, when selected, presents employer Acme with detailed information regarding health insurance subsidies provided to employees within a “health subsidy” tab 216b. A second navigation control 214b, when selected, presents employer Acme with detailed information regarding disability insurance subsidies provided to employees within a “disability subsidy” tab 216c. A third navigation control 214c, when selected, presents employer Acme with information regarding life insurance subsidies within a “life subsidy” tab 216d.

In a present “overview” tab 216a, the dashboard 200 provides a number of selectable controls to employer Acme, organized within a series of information panes 204, 206, 208, 210, and 212. In the first information pane 204, the dashboard 200 provides de-identified (e.g., anonymous) information regarding employee profile information and employee medical history data collected from subscribers employed by employer Acme. In some implementations, a “view all” control 218, when selected, presents employer Acme with personal information, including aggregated profile information (e.g., zip code distribution or geographic region distribution) and demographic information (e.g., age distribution, gender distribution, race distribution, etc.). The medical history information presented by the “view all” control 218, for example, may present information regarding insurance claims filed by employees of Acme Co. via the insurance exchange system and environment. If employees of Acme Co. uploaded external medical history records, the “view all” control 218 may provide employer Acme with a comprehensive review of aggregated and de-identified medical history data.

If employer Acme wishes to link employee medical history data gleaned from electronic medical records to the dashboard interface 200, in some implementations, employer Acme selects an “upload medical histories” control 222. The control 222, upon selection, may execute a de-identification process via the insurance exchange system so that the insurance exchange system may share subscriber medical history, upon individual employee authorization, as de-identified data. In this manner, employer Acme may access information regarding employees without incurring privacy concerns. The de-identification process, for example, may be based upon governmental guidelines, such as the U.S. Health Insurance Portability and Accountability Act (HIPAA) guidelines of 1996.

Alternatively, in other implementations, selection of the “upload medical histories” control 222 may provide employees with a connection between the insurance exchange system and a third party electronic medical record repository. Upon authorization and validation of each individual employee subscriber, for example, the individual subscriber's electronic medical records (or a portion thereof) may be accessed via the insurance exchange system. In this manner, in some examples, the insurance exchange system can provide Acme's employees with value-added features based upon analysis of the contents of the electronic medical records, as described above in relation to FIG. 1.

In some implementations, employer Acme can choose to authorize access the de-identified medical history data by one or more insurance carriers. By selecting an “authorize access by carrier” control 220, for example, employer Acme may authorize the insurance exchange system to share employee medical history information with one or more carriers, such as the carriers associated with employer sponsored health insurance plans (e.g., described in relation to information pane 208), employer sponsored life insurance plans (e.g., described in relation to information pane 210), and/or employer sponsored disability insurance plans (e.g., described in relation to information pane 212). The data shared with each carrier may correspond to only those employees who have subscribed to plans offered by the particular carrier. In another example, all employee data is shared, in anonymous fashion, with either each carrier within the insurance exchange system or each carrier sponsored by employer Acme.

In some implementations, employer Acme may select a “comparisons to other companies in your sector” control 224 to view a comparison between de-identified information gleaned from the user profiles and/or user medical records of employees of employer Acme and de-identified aggregate information gleaned from employees of other similar employers. The comparison, for example, may identify additional entities used for comparison based upon business sector (e.g., known competitors). In other examples, the dashboard may present companies for comparison based on geographic location, size, and/or maturity. The competitors may be anonymized, for example listed as “Competitor A” rather than as “Sprocket Co.” In presenting a comparison, main factors contributing to differences in risk scores between the companies may be highlighted. For example, Competitor A may have a greater number of employees with children, while Acme Co. has a greater number of employees close to retirement age. The companies selected for comparison, in some embodiments, include other employers within the insurance exchange system and environment. In some embodiments, one or more companies selected by the dashboard for comparison are not members of the insurance exchange system and environment. For example, the insurance exchange system and environment may import data provided from an external source to increase visibility in risk scores, medical history trends, premium levels, and other factors in the insurance industry.

Turning to the risk score information pane 206, a “your group risk score” control 226, upon selection, presents employer Acme with information regarding the group risk score assigned to Acme. The group risk score is based upon risk scores of the employees of Acme Co. as well as additional (e.g., dependent) subscribers of employee plans. The risk score information, in some examples, may include the total score as well as, optionally, individual factors contributing to the group risk score. Alternatively, rather than presenting the information upon selection of the “your group risk score” control 226, the risk score pane 206 may present a total risk score value (e.g., in the position of the “your group risk score” control 226), while additional controls within the risk score pane 206 may present details underlying the composition of employer Acme's group risk score.

In some implementations, employer Acme selects a “primary factors affecting your group risk score” control 230 to learn about the composition of the group risk score. For example, a number of factors may contribute to a group risk score computation model such as, in some examples, median or average age of employee population, gender ratio, race composition, geographic region(s) where the employees work, type of industry (e.g., riskiness of job-related tasks) and medical claims history. The primary factors, for examples, may be based upon analysis of group medical claims and/or pharmacy claims data. To further refine information, if employer Acme is a large employer having a number of physical locations and/or a number of types of business units, factors affecting the group risk score may be analyzed, in some examples, on a per-locale or geographic region basis, a per-job-capacity basis (e.g., manufacturing compared to engineering, etc.), and/or a per-corporate-division basis (e.g., a retail entity broken down by store type or name).

In some implementations, analysis of the primary factors involves reviewing self-reported health assessment information. For example, employees may be provided a survey to determine attitudes, beliefs, motivators, and/or present wellness behaviors (exercise levels, eating habits, etc.). In another example, employers may provide on-site biometric screenings or other health assessments to employees as part of a wellness program. The primary factors may include factors that could be influenced by employer Acme through health improvement programs and employee competitions. Factors within the influence of employer Acme, for example, include smoking status, weight, and/or blood pressure. The “primary factors affecting your risk score” control 230 may present the risk score factors to employer Acme to encourage employer Acme to take the initiative with employee programs to improve the group risk score. In some circumstances, a portion of the statistics presented may only take into account the employees of employer Acme, rather than including dependents of the employees, such that internal programs are planned according to the needs of those working for employer Acme.

Furthermore, in some implementations, employer Acme may contribute data regarding employees for use in risk score analysis. For example, should employer Acme offer one or more wellness programs, participation in the wellness programs (e.g., a walking program, bicycling to work program, weight loss program, etc.) may be reported to the insurance exchange system for analysis to further refine and revise factors contributing to the risk assessment score. In another example, employer Acme may submit reports of sick days accrued, disability reporting, workers' compensation reporting, incidental employee absenteeism, and/or utilization of vacation days as evidence of wellness levels of employees. The data supplied by employer Acme may be aggregated anonymous data and/or data representative of individual employees (e.g., based upon privacy rights, employee opt-in (or opt-out) of program analysis, etc.).

In some implementations, the “primary factors affecting your group risk score” control 230, upon selection, presents employer Acme with an estimate of the costs associated with employees at higher medical risk than average. For example, the employees may be categorized based upon assessed risk involving one or more factors. The categories, in some examples, may include “normal”, “moderate”, and “high” risk, “low”, “average”, and “high” risk, or percentile risk (e.g., average, 75^{th} percentile, 95^{th} percentile, etc.). In a particular example, employee salary information is combined with employee absenteeism to estimate a cost of productivity loss. In another example, medical claims data is aggregated to compare medical claims costs between the different categories of employees.

A “compare to averages for other companies in your sector” control 232 is selectable to cause display of a comparison of a group risk score of employer Acme (illustrated via “your group risk score” control 226) to additional employers. The comparison, for example, may identify additional employers used for comparison based upon business sector (e.g., known competitors). In other examples, the dashboard may present employers for comparison based on geographic location, size, and/or maturity. The competitors may be anonymized, for example listed as “Competitor A” rather than as “Sprocket Co.” In presenting a comparison, modifiable factors contributing to differences in risk scores between the companies may be highlighted. For example, Competitor A may have a greater number of smokers within the work force, while Acme Co. has a lower average BMI. The employers selected for comparison, for example, include other employers within the insurance exchange system and environment. In another example, one or more companies selected by the insurance exchange system for comparison are not members of the insurance exchange system and environment. For example, the insurance exchange system and environment may import data provided from an external source to increase visibility in risk scores, medical history trends, premium levels, and other factors in the insurance industry.

In some implementations, the “compare to averages for other companies in your sector” control 232, upon selection, presents employer Acme with a comparison of estimated costs accrued by employer Acme in comparison to peers due to employees with escalated health risks. In one example, aggregate estimated cost of productivity loss of employees of employer Acme is compared to aggregate estimated costs of productivity loss for a number of peer employers.

In some implementations, employer Acme selects a “risk scores provided by carriers” control 228 to review risk scores determined by individual insurance carriers. The insurance carriers, for example, may each use internal algorithms for determining risk score. The factors contributing to risk scores generated by insurance carriers may or may not be known. For example, the insurance carrier may optionally volunteer information regarding factors which contribute to risk score determinations.

The three remaining information panes 208, 210, and 212 share identical controls, each set of controls providing information related to the various insurance plans subscribed to by employees of Acme Co. and/or sponsored by Acme Co. for employee selection. As such, the health insurance plan pane 208, the life insurance plan pane 210, and the disability insurance plan pane 212 are described in general as containing insurance plan controls 234, 236, 238, and 240. However, the information presented will differ, upon selection of the insurance plan controls 234, 236, 238, and 240, based upon the type of insurance plan being reviewed by employer Acme.

A “summary of current plan offerings” control 234, when selected, presents employer Acme with summary information regarding one or more insurance plans sponsored by Acme Co. The summary information, in the example of health insurance plans, may include co-pay information, network providers, deductible information, and other health plan features. Similarly, the summary information, in the example of a life insurance plan, may include term, rate, death benefit, accidental death benefit, and present value. If employer Acme sponsors two or more insurance plans within a particular category (e.g., health, life, or disability insurance) or, alternatively, employer Acme has employees subscribed to two or more insurance plans within a particular category, the dashboard may present employer Acme with information related to each of the two or more insurance plans. In one example, the insurance plan information may be presented side-by-side, for example in a comparison format. In another example, the dashboard may present a list of current insurance plans to employer Acme, upon selection of the “summary of current plan offerings” control 234, and employer Acme may select a particular plan for review.

To compare the present coverage with coverage offered by competitors, in some implementations, employer Acme selects a “compare to coverages offered by other companies in your sector” control 238. Upon selection of the “compare to coverages offered by other companies in your sector” control 238, the employer dashboard 200 may present employer Acme with information regarding insurance plans sponsored by competitors of Acme. If, instead, Acme provides employees with a defined contribution, the dashboard 200, upon selection of the “compare to coverages offered by other companies in your sector” control 238, may present a comparison of defined contribution levels provided by additional employers. As described above in relation to controls 224 and 232, the additional employers may be selected based upon a number of factors and may optionally be presented in an anonymous fashion. Additionally, if employer Acme offers a defined contribution rather than a selection of sponsored plans, employer Acme may be compared, in some embodiments only to other employers offering a defined contribution.

A “ratings of current plans relative to peers” control 240, presents, upon selection by employer Acme, information regarding user ratings (e.g., subscriber ratings and/or employer ratings) submitted regarding the insurance plans subscribed to by employer Acme in comparison to user ratings submitted regarding the insurance plans subscribed to by other employers identified as peers of employer Acme. Identification of an employer as a peer, in some examples, can include comparing employer demographic information of the employer Acme to additional employers external and/or internal to the insurance exchange environment. In one example, the peers of employer Acme include other employers within a same employment sector. The demographics, in other examples, can include geographic location, size, and/or maturity. The ratings, for example, may be based upon a sliding scale, number of stars, or other rating mechanism demonstrating a level of satisfaction a particular subscriber or employer has with a particular insurance plan. Ratings of peers external to the insurance exchange environment may be obtained, in some examples, through contractual arrangements with third-parties or carriers, public domain information, ‘estimated’ or calculated ratings generated within the health exchange environment, rating boards, or standardized reporting mechanisms, among others. In one example, various aspects of a plan may be rated separately. For example, the insurance exchange system may maintain (and/or obtain) separate subscriber customer service ratings, employer customer service ratings, subscriber billing ratings, and employer billing ratings for each carrier. The insurance exchange system, in another example, may maintain (and/or obtain) separate provider network ratings, plan feature ratings, and economic value ratings associated with each health plan offered by a particular carrier.

Should employer Acme discover that competitors appear to offer superior benefits in one or more insurance product areas (e.g., health insurance, life insurance, or disability insurance), in some implementations, employer Acme selects an “options from other carriers” control 236 to review products not presently subscribed to by employer Acme.

Although the employer dashboard 200 is described in general terms, the controls presented may vary depending upon the level of employee accessing the dashboard 200. For example, a benefits professional or human resources representative may be provided only a subset of the controls presented to a board member or managing officer. Similarly, the information accessible via the tabs 216 may change depending upon the level of user accessing the information.

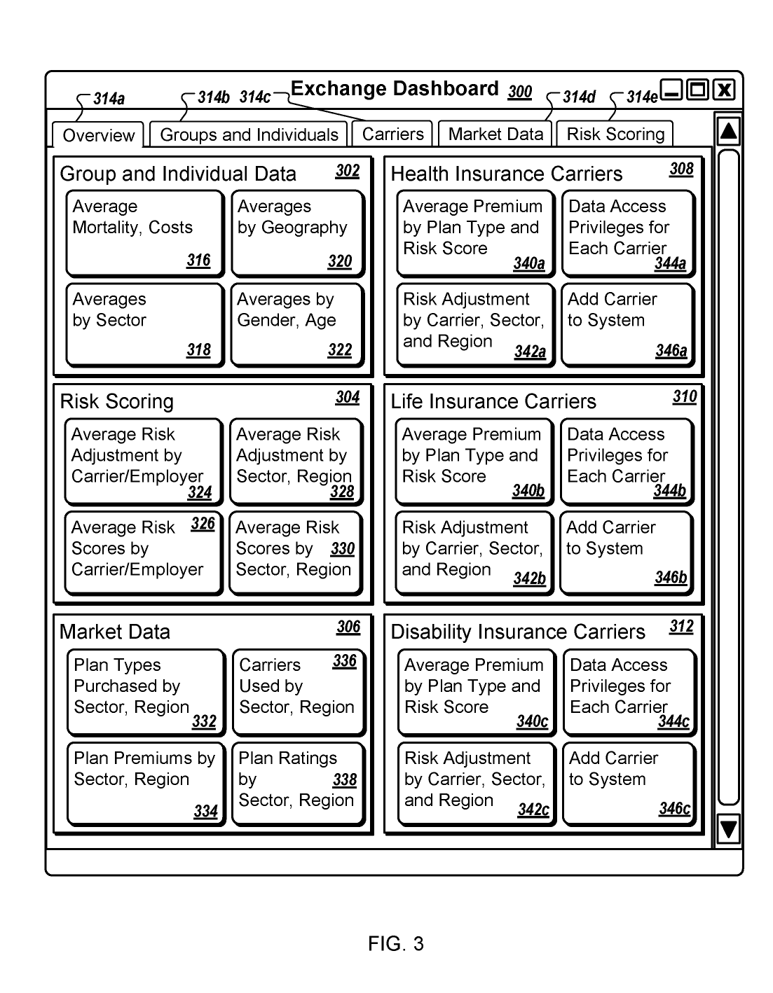

FIG. 3 is a screen shot of an example insurance exchange dashboard user interface 300 for accessing information about an insurance exchange system. The dashboard 300 is part of a web site, web portal, personal computer application, or mobile device application configured to allow a member of the insurance exchange system team to review analytics regarding the insurance exchange system and environment.

The dashboard 300 includes a group and individual data pane 302 presenting information regarding claims analytics across individual subscribers and/or groups (e.g., demographic groups, employment sector groups, etc.). A more detailed overview of the information represented in the group and individual data pane 302 is accessible using a “groups and individuals” tab 314b. The “groups and individuals” tab 314b, for example, may present the user with small graphical displays representing a portion of the analytics accessible through the group and individual data pane 302. In the group and individual data pane 302, an “average mortality, costs” control 316, when selected, presents a user with analytics regarding the costs incurred (e.g., insurance claims, prescription drug costs, and/or other reimbursement expenses) by subscribers of the insurance exchange system and environment. The costs, for example, may be broken down by timeframe (e.g., daily, weekly, monthly, quarterly, etc.). In another example, the costs may be broken down by insurance product type (e.g., health insurance, life insurance, disability insurance, etc.). The mortality data, similarly, may illustrate average anticipated mortality age of subscribers of the insurance exchange system and environment (e.g., based upon risk score and age analysis), also broken down by timeframe and (optionally) insurance product type subscribed to. For example, not all subscribers will carry all insurance types through the insurance exchange system and environment.

Beneath the “average mortality, costs” control 316, an “averages by sector” control 318, upon selection, may present the user with a breakdown of the overall data described above, on a per-sector basis. The sectors, for example, may include a variety of employment sectors (e.g., medical, technological, academic, manufacturing, retail, services, etc.) and other subscriber classifications, such as “retired”, “student”, “minor”, and “unemployed.” The averages by sector presented in response to selection of the “averages by sector” control 318 may include comparisons of cost and/or mortality data between the various sectors. In one example, the dashboard 300 may present a ranking of the sectors, such as the highest cost sector to lowest cost sector.

The group and individual data pane 302 also includes an “averages by geography” control 320, selectable for presentation of a breakdown of the overall data described above in relation to control 316, on a geographical region basis. The geographical regions, for example, may include a series of refinements of information starting on a per country or per continent basis, and reducing to a state, province, or in-state region (e.g., zip code or county). The averages by geography presented in response to selection of the “averages by geography” control 318 may include comparisons of cost and/or mortality data between the various geographical areas. In one example, the dashboard 300 may present a ranking of the geographical regions, such as the youngest average age of mortality geographical region to oldest average age of mortality geographical region.

Beneath the “averages by geography” control 320, an “averages by gender, age” control 322, upon selection, may present the user with a breakdown of the overall data described above, on a per-gender and/or per-age range basis. The age ranges, for example, may include subscriber classifications, such as “infant,” “minor,” “adult,” and “senior citizen.” In another example, age ranges may include age spans of individual subscribers based upon stages of maturity, such as infant (e.g., about 0 to 2), preschool (e.g., about 3 to 5), grade school (e.g., about 6 to 10), junior high (e.g., about 11 to 13), high school (e.g., about 14 to 17), college (e.g., about 18 to 23), early adulthood (e.g., about 24 to 34), on up to retirement (e.g., 64+) and/or geriatric. Other age ranges may be set by even time frames (e.g., 5, 10, or 20 year segments). The averages by gender and/or age presented in response to selection of the “averages by gender, age” control 318 may include comparisons of cost and/or mortality data between the various age ranges and/or the two genders. In one example, the dashboard 300 may present a ranking of the age ranges, such as the highest cost age range (and, optionally gender within the age range) to lowest cost age range.

Although illustrated as separate controls 316, 318, 320, and 322, in some implementations, the user may select the “groups and individuals” tab 314b to access more detailed analytics of the average mortality and costs data, such as averages by employment sector within selected geographical regions, averages by gender within selected employment sectors, or averages by age and further by gender within selected geographical regions. Any combination may be possible. Further, the data may be illustrated numerically, in a bar graph, pie chart, line graph, or other visual layout presented to allow the user to quickly synthesize the information.

Turning to a risk scoring pane 304 and corresponding “risk scoring” tab 314e, the user selects the available controls to access information regarding risk analytics across individual subscribers and/or groups (e.g., demographic groups, employment sector groups, etc.). The “risk scoring” tab 314e, for example, may present the user with small graphical displays representing a portion of the analytics accessible through the risk scoring pane 304.

In the risk scoring pane 304, an “average risk adjustment by carrier/employer” control 324, when selected, presents a user with analytics regarding risk adjustments applied to carriers by the insurance exchange system based upon subscriber pool, as well as risk adjustments associated with various employers. A risk adjustment strategy employed by the insurance exchange system redistributes premiums to the affiliated carriers based upon risk scoring of subscriber pools of each carrier. As risk scores can be applied both prospectively (e.g., based upon anticipated costs associated with the subscriber) and retrospectively (e.g., based upon actual claims data accrued by a particular subscriber), the risk adjustment strategy can similarly work in a prospective and/or retrospective manner. The risk adjustment strategy is designed to allocate premium adjustments to the carriers affiliated with the insurance exchange system such that premium payments are allocated according to risk (e.g., anticipated or actual cost) born by each individual carrier. In this manner, the insurance exchange system redistributes the risk of providing coverage for the least healthy (highest cost/highest risk) participants, thereby reducing the incentive for individual carriers to increase premiums based upon risk analysis of the subscriber pool and enhancing stability in future premium levels. A positive assessed risk is applied to those carriers with subscribers having a lower than average aggregate risk score, and a negative assessed risk is applied to those carriers with subscribers having a higher than average aggregate risk score. Should a carrier's aggregate risk score match the average of the insurance exchange system, that carrier is allocated a neutral risk assessment (e.g., “0” risk adjustment). When premiums are paid into the insurance exchange system by the employers and/or individual subscribers, the premium payments to each of the carriers are adjusted according to their individual risk assessments. Example risk assessment and premium adjustment schemes are described in greater detail in U.S. patent application Ser. No. 13/231,601 to Sperling, entitled “Risk Adjusted Insurance Exchange with Sustainable Premiums” and filed Sep. 13, 2011, incorporated herein by reference in its entirety. Returning to the “average risk adjustment by carrier/employer” control 324, in the circumstance of a large employer (e.g., international, multi-national, or multi-regional employer), the information may be broken down by geographic area and/or business subsidiary. The risk adjustments, furthermore, may be separated by insurance product type (e.g., health insurance, life insurance, disability insurance, etc.).

By selecting an “average risk adjustment by sector, region” control 328, the risk adjustments applied through the insurance exchange system may be broken down by employment sector and/or geographical region. The sectors, for example, may include a variety of employment sectors and other subscriber classifications, such as “retired”, “student”, “minor”, and “unemployed.” The average risk adjustments by sector presented in response to selection of the “average risk adjustment by sector, region” control 328 may include comparisons of risk adjustment between the various employment sectors. In one example, the dashboard 300 may present a ranking of the employment sectors, such as the most negative (greatest overall risk) risk-adjusted sector to most positive (lowest overall risk) risk-adjusted sector. In terms of geographical regions, the dashboard 300 may offer a series of refinements of information starting on a per-country or per continent basis, and reducing to a state, province, or in-state region (e.g., zip code or county).

In addition to risk adjustment data, the risk scoring pane 304 presents information regarding risk scores, such as an “average risk scores by carrier/employer” control 328 which breaks down risk scores by carrier and/or employer in a manner similar to that of risk adjustments (described above in relation to control 324) and an “average risk scores by sector, region” control 330 which breaks down risk scores by sector and/or region in a manner similar to that of risk adjustments, described above in relation to control 328. These risk scores, for example, may be tracked over time to assess overall risk in the system as well as areas in which risk is increasing (or decreasing) at the greatest rate.

Although illustrated as separate controls 324, 326, 328, and 330, in some implementations, the user may select the “risk scoring” tab 314e to access more detailed analytics of the risk adjustment and risk score data, such as averages by employment sector within selected geographical regions, averages by carrier within selected employment sectors, or averages by carrier within selected geographical regions. Any combination may be possible. Further, the data may be illustrated numerically, in a bar graph, pie chart, line graph, or other visual layout presented to allow the user to quickly synthesize the information.

Turning to a market data pane 306 and corresponding “market data” tab 314d, the user selects the available controls to access information regarding plan subscription trends and consumer ratings. The “market data” tab 314d, for example, may present the user with small graphical displays representing a portion of the analytics accessible through the market data pane 306. In the market data pane 306, a “plan types purchased by sector, region” control 332, when selected, presents a user with analytics regarding insurance product purchase on a per-sector and/or per-region basis. The plan types, for example, may be separated into major divisions (e.g., health insurance, life insurance, disability insurance) as well as sub-divisions thereof. For example, in relation to health insurance, the dashboard 300 may present information regarding purchase trends in family coverage health insurance, individual coverage health insurance, and subscriber plus one health insurance. Furthermore, the dashboard 300 may present information regarding purchase trends in types of health insurance, such as preferred provider organization (PPO), exclusive provider organization (EPO), and health maintenance organization (HMO). If the insurance exchange system provides standardized plan types, the level of specificity may reduce further, such as to a plan type level of particular sub-division, by health insurance type and further by feature set. In a particular example, the dashboard 300, via the “plan types purchased by sector, region” control 332, may present subscription volume (or percentage) data regarding PPO-type individual coverage insurance with a two thousand dollar deductible. The user may review information, by selecting the “plan types purchased by sector, region” control 332, that is broken down by employment sector and/or geographical region. The sectors, for example, may include a variety of employment sectors and other subscriber classifications, such as “retired”, “student”, “minor”, and “unemployed.” The plan type purchases by sector presented in response to selection of the “plan types purchased by sector, region” control 332 may include comparisons of the number of subscriptions purchased per plan type between the various employment sectors. In another example, the dashboard 300 may present an analysis of market share by plan type and region. In one example, the dashboard 300 may present a perceived underutilization of product type within one or more of the employment sectors, such as underutilization of disability insurance within a particular employment sector. In terms of geographical regions, the dashboard 300 may offer a series of refinements of information starting on a per-country or per continent basis, and reducing to a state, province, or in-state region (e.g., zip code or county).

A “plan premiums by sector, region” control 334, upon selection, causes the dashboard 300 to present the user with analytics regarding premium costs on a per-sector and/or per-region basis. In illustrating premiums analytics, the dashboard 300 may separate the insurance subscription data into major divisions (e.g., health insurance, life insurance, disability insurance). The sectors, for example, may include a variety of employment sectors and other subscriber classifications, such as “retired”, “student”, “minor”, and “unemployed.” The dashboard 300, in one example, may present information regarding average, median, and range of premiums charged to students. In terms of geographical regions, the dashboard 300 may offer a series of refinements of information starting on a per-country or per continent basis, and reducing to a state, province, or in-state region (e.g., zip code or county). In another example, the dashboard 300 may present a ranking of the geographic regions (e.g., major geographic areas of the United States), such as the highest premium region to lowest premium region.

By selecting a “carriers used by sector, region” control 336, the dashboard 300 presents the user with analytics regarding carrier subscriptions on a per-sector and/or per-region basis. The subscriptions may be separated into major divisions (e.g., health insurance, life insurance, disability insurance). The dashboard 300, in one example, may present information regarding relative market share between carriers competing in a particular geographic region. In another example, the dashboard 300 may present information regarding top carriers within a subset of market sectors, such as the top carriers selected by retirees. The sectors, for example, may include a variety of employment sectors and other subscriber classifications, such as “retired”, “student”, “minor”, and “unemployed.” In terms of geographical regions, the dashboard 300 may offer a series of refinements of information starting on a per-country or per continent basis, and reducing to a state, province, or in-state region (e.g., zip code or county).

The user, in some implementations, selects a “plan ratings by sector, region” control 338 to review analytics regarding plan ratings on a per-sector and/or per-region basis. The ratings, for example, may be based upon a sliding scale, number of stars, or other rating mechanism demonstrating a level of satisfaction a particular subscriber or employer has with a particular carrier or insurance plan. In one example, various aspects of a plan and/or insurance carrier may be rated separately. For example, the ratings and insurance exchange system may maintain separate subscriber customer service ratings, employer customer service ratings, subscriber billing ratings, and employer billing ratings for each carrier. The insurance exchange system, in another example, may maintain separate provider network ratings, plan feature ratings, and economic value ratings associated with each health plan offered by a particular carrier. The plan subscriptions may be separated into major divisions (e.g., health insurance, life insurance, disability insurance). The dashboard 300, in one example, may present information regarding relative approval of a particular plan or a plan type (e.g., life insurance plans) offered by a particular carrier based upon ratings submitted by subscribers residing in various geographic regions. In another example, the dashboard 300 may present information regarding top-rated carriers within a subset of market sectors, such as the top carriers selected by technology employers. The sectors, for example, may include a variety of employment sectors and other subscriber classifications, such as “retired”, “student”, “minor”, and “unemployed.” In terms of geographical regions, the dashboard 300 may offer a series of refinements of information starting on a per-country or per continent basis, and reducing to a state, province, or in-state region (e.g., zip code or county).

Although illustrated as separate controls 332, 334, 336, and 338, in some implementations, the user may select the “market data” tab 314d to access more detailed analytics of the market data, such as plan ratings relative to plan premium rates, geographically. Any combination may be possible. Further, the data may be illustrated numerically, in a bar graph, pie chart, line graph, or other visual layout presented to allow the user to quickly synthesize the information.

The three remaining information panes 308, 310, and 312 of the dashboard 300 share identical controls, each set of controls providing information related to the various insurance plans available to employers and/or subscribers interacting with the insurance exchange system and environment. As such, the health insurance plan pane 308, the life insurance plan pane 310, and the disability insurance plan pane 312 are described in general as containing insurance plan controls 340, 342, 344, and 346. However, the information presented will differ, upon selection of the insurance plan controls 340, 342, 344, and 346, based upon the type of insurance plan being reviewed by the user. Furthermore, detailed information regarding insurance carrier analytics is available to the user by navigating to a “carriers” tab 314c.

In some implementations, the user selects an “average premium by plan type and risk score” control 340 to review average premiums charged by carriers based upon a plan type (e.g., health insurance plans 340a, life insurance plans 340b, or disability insurance plans 340c) and a risk score. The risk score may encompass a numeric value. In another example, the risk score encompasses a range of numeric values. Further, upon selection of the “average premium by plan type and risk score” control 340, the user may be presented with information regarding the largest increases in premiums (e.g., between a risk score of X and a risk score of Y).

Through selection of a “risk adjustment by carrier, sector, and region” control 342, the insurance exchange dashboard 300 presents a user with risk adjustment values applied to the applicable product type (e.g., health insurance products 342a, life insurance products 342b, or disability insurance products 342c) per carrier on a regional and/or employment sector basis. The risk adjustment values, in one example, may be tracked over a period of time, such as monthly, quarterly, or annually.

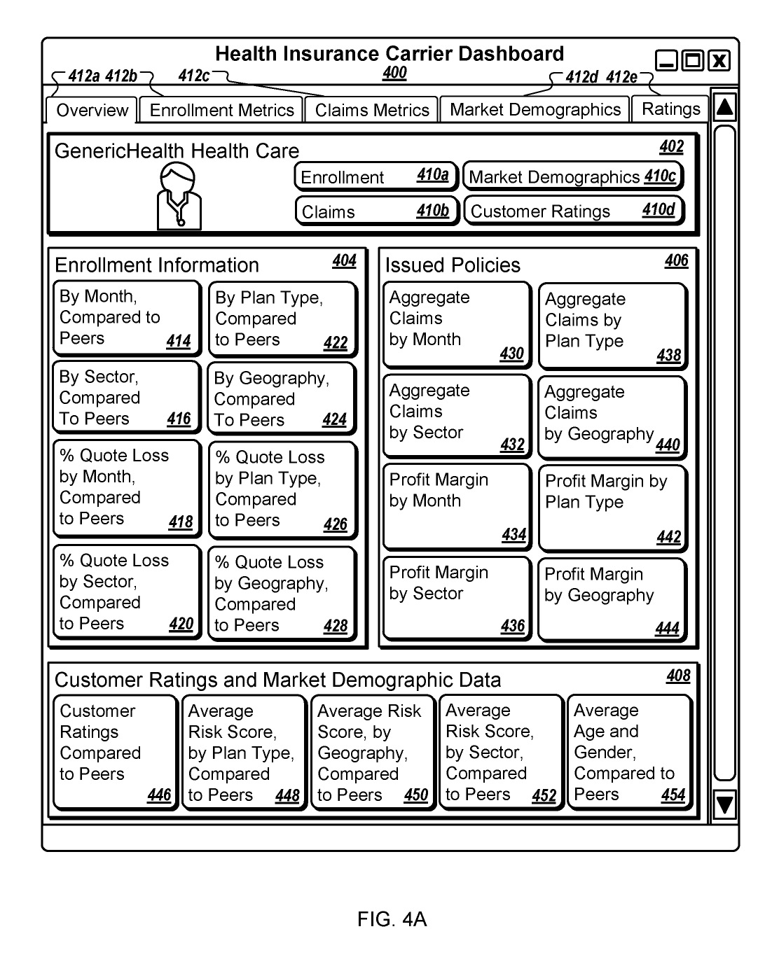

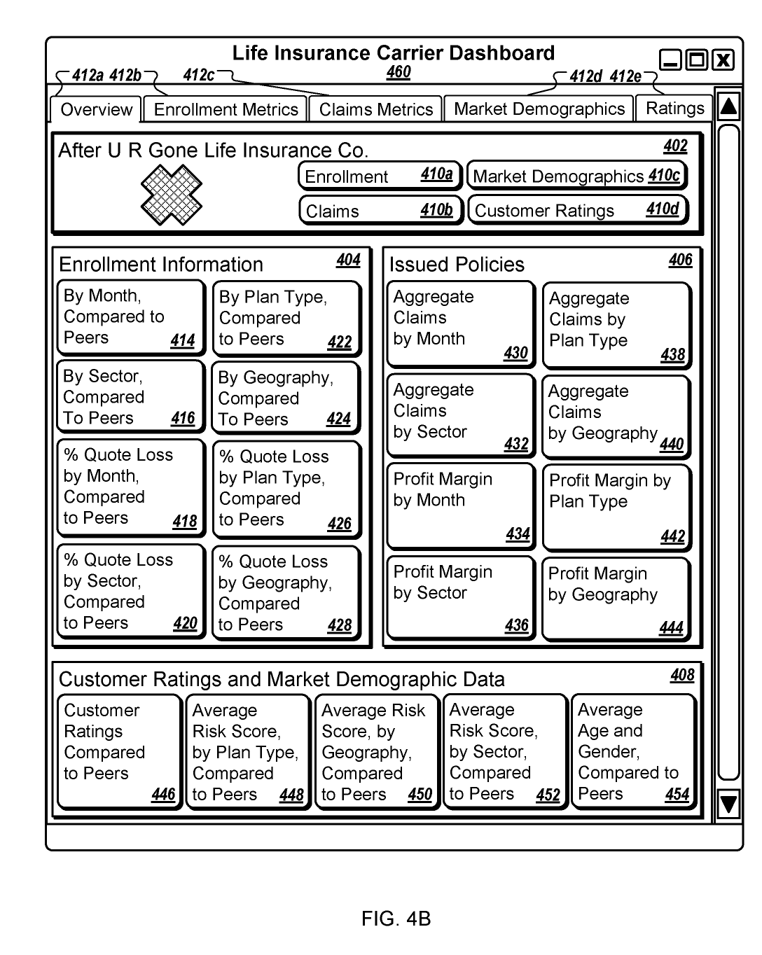

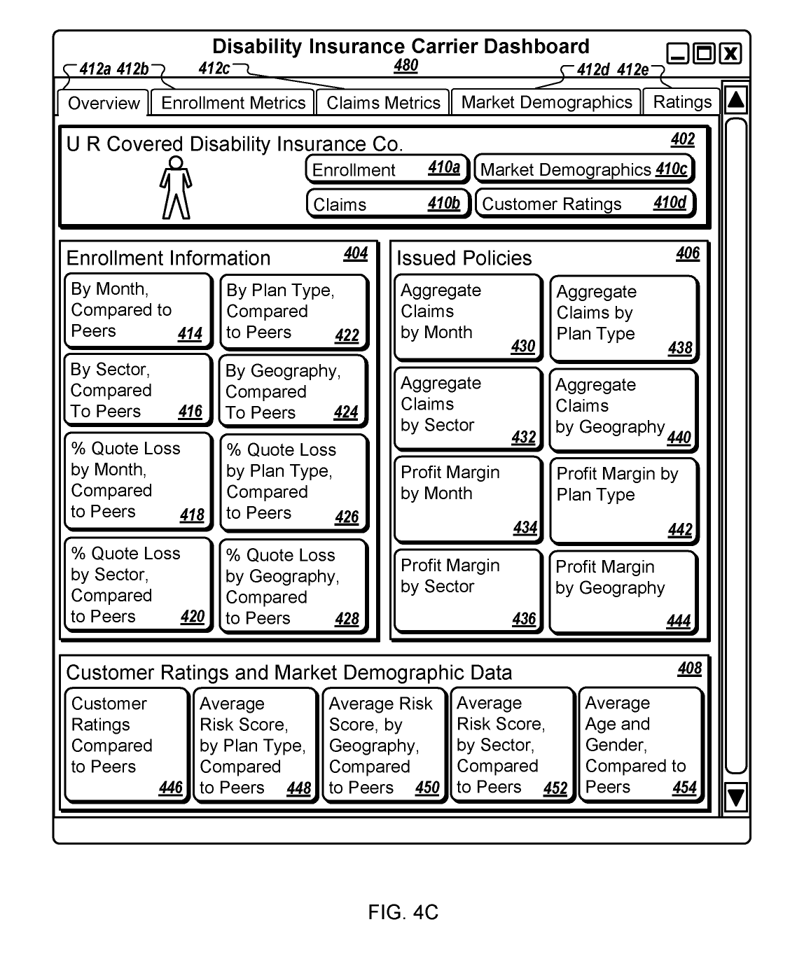

The dashboard 300, upon selection of a “data access privileges for each carrier” control 344, presents access privileges allocated to each carrier of the particular carrier type (e.g., health insurance carries 344a, life insurance carriers 344b, or disability insurance carriers 344c) within the insurance exchange system. The access level of a particular carrier may vary based upon the level of information shared by the carrier with the insurance exchange system and environment. In another example, the access level of a particular carrier may depend upon regional laws, such as privacy mandates applied on a per-country, per-state, or per-province basis. The access level, furthermore, may be based in part upon a fee structure charged by the insurance exchange system and environment. For example, the insurance exchange system may charge a monthly or annual fee to carriers for providing access to analytics data. A portion of the analytics data is discussed in relation to FIGS. 4A through 4C, below.

When the user selects an “add carrier to system” control 346, in some implementations, the user is presented with a user interface for adding carrier information, plan information, and other data necessary to add a carrier to the insurance exchange system and environment. The carrier addition process, in some embodiments, includes plan type templates for adding information regarding the carrier's insurance plans. For example, upon selection of the “add carrier to system” control 346c, the user may be presented with a disability insurance plan template for importing information regarding one or more disability insurance plans offered by the new carrier. When adding a new carrier, in some embodiments, the insurance exchange system standardizes the plan offerings of the carrier such that plans offered through the insurance exchange system may be compared and/or ported more easily.

Although the dashboard 300 is described in general terms, the controls presented may vary depending upon the level of employee accessing the dashboard 300. For example, a carrier coordinator or employee benefits coordinator may be provided only a subset of the controls presented to a board member or managing officer of the insurance exchange system. Similarly, the information accessible via the tabs 314 may change depending upon the level of user accessing the information.

FIGS. 4A through 4C illustrate example dashboards for insurance carriers to review analytical information and business information related to subscriptions managed within the insurance exchange system and environment. In some implementations, a portion of the data presented within the insurance carrier dashboards is accessible only to the particular carrier reviewing the information. The insurance carrier may link the portion of the data (e.g., private data) to the insurance exchange system and environment from a database maintained and managed by the particular insurance carrier. Similar to an individual subscriber linking in medical history records, the insurance carrier may opt to link in privately held data to manage and coordinate data points from within the insurance exchange system and environment. Furthermore, in some implementations, the carrier is provided the opportunity to share a portion of its private data, in a de-identified manner, to enhance analytics managed by coordinating members of the insurance exchange system.

FIG. 4A is a screen shot of an example health insurance carrier dashboard user interface 400 for accessing health insurance carrier information via an insurance exchange system. The dashboard 400 is part of a web site, web portal, personal computer application, or mobile device application configured to allow the carrier (e.g., plan coordinator, actuary, board member, or other corporate official) to interface with the insurance exchange system and environment. As illustrated, carrier “GenericHealth” is connected to the dashboard 400.

In a welcome pane 402, carrier GenericHealth is presented with four navigation controls 410, correlating to four additional tabs 412 at the top of the dashboard 400. A first navigation control 410a, when selected, presents carrier GenericHealth with detailed information regarding subscriber enrollment within an “enrollment metrics” tab 412b. A second navigation control 410b, when selected, presents carrier GenericHealth with detailed information regarding insurance claims filed on behalf of enrolled subscribers via the insurance exchange system and environment within a “claims metrics” tab 412c. A third navigation control 410c, when selected, presents carrier GenericHealth with information regarding market demographics within a “market demographics” tab 412d. A fourth navigation control 410d, when selected, presents carrier GenericHealth with information regarding customer ratings within a “ratings” tab 412e.

In a present “overview” tab 412a, the dashboard 400 provides a number of selectable controls to carrier GenericHealth, organized within a series of information panes 404, 406, and 408. In the first information pane 404, the dashboard 400 provides de-identified (e.g., anonymous) information regarding subscriber enrollment in plans provided by carrier GenericHealth in comparison to subscriber enrollment captured by other carriers. The peers of carrier GenericHealth may include all other health insurance carriers participating within the insurance exchange system and environment. Peers of GenericHealth, in some embodiments, are selected based upon identification of competitors to GenericHealth. For example, the enrollment information statistics presented via the first information pane 404 may represent comparisons between carrier GenericHealth and carriers within a threshold aggregate premium (e.g., aggregate premiums of all subscribers of all health plans) of GenericHealth. In another example, carrier GenericHealth is compared to at least 4 most similar competitors. Similarities used in identifying peers to GenericHealth can include, in some examples, a threshold percentage difference in total enrollment (e.g., health insurance carriers having an enrollment within twenty percent of GenericHealth's enrollment), overlapping geographical markets, overlapping employment sector markets, and overlapping plan types offered. In some embodiments, the insurance exchange system anonymizes the peers. For example, a peer of carrier GenericHealth may be listed as “Competitor A” rather than as “CommonHealth Inc.”

The statistics are represented by a number of selectable controls, including an enrollment “by month, compared to peers” control 414, an enrollment “by sector, compared to peers” control 416, an enrollment “by geography, compared to peers” control 424, and an enrollment “by plan type, compared to peers” control 422. Although illustrated as separate controls 414, 422, 416, and 424, in some implementations, carrier GenericHealth may select the “enrollment metrics” tab 412b to access more detailed analytics of the enrollment information, such as enrollment by month and further by geography, or enrollment by plan type and further by sector. Any combination may be possible. Further, the data may be illustrated numerically, in a bar graph, pie chart, line graph, or other visual layout presented to allow carrier GenericHealth to quickly synthesize the information. The sectors, for example, may include a variety of employment sectors and other subscriber classifications, such as “retired”, “student”, “minor”, and “unemployed.” Plan types can include, in some examples, family coverage health insurance, individual coverage health insurance, and subscriber plus one health insurance. In another example, plan types include managed care types, such as preferred provider organization (PPO), exclusive provider organization (EPO), and health maintenance organization (HMO). Furthermore, plan types may be broken down in terms of major features included, such as by deductible level and/or copay level, or including premium features such as “including vision benefit” and “including infertility benefits.” In terms of geographical regions, the dashboard 400 may offer a series of refinements of information starting on a per-country or per continent basis, and reducing to a state, province, or in-state region (e.g., zip code or county).

Beneath the positive enrollment statistic controls 414, 422, 416, and 424, a set of percentage quote loss controls 418, 420, 426, and 428 provide carrier GenericHealth with insight into opportunities quoted by carrier GenericHealth that were never accepted by subscribers of the insurance exchange system and environment. The level of quoted opportunities that failed to lead to enrollment of a new subscriber, as made available by the percentage quote loss controls 418, 420, 426, and 428, are compared to levels of quoted opportunities that failed to lead to enrollment of a new subscriber for peers of carrier GenericHealth. The controls include the “percentage quote loss by month, compared to peers” control 418, the “percentage quote loss by sector, compared to peers” control 420, the “percentage quote loss by plan type, compared to peers” control 426, and the “percentage quote loss by geography, compared to peers” control 428. Peers, geographical regions, plan types, and employment sectors may be identified as described above in relation to the positive controls 416, 422, and 424. In some implementations, carrier GenericHealth may select the “enrollment metrics” tab 412b to access more detailed analytics of the percentage quote loss information, such as percentage quote loss by month and further by sector, or percentage quote loss by plan type and further by geography. Any combination may be possible. Further, the data may be illustrated numerically, in a bar graph, pie chart, line graph, or other visual layout presented to allow carrier GenericHealth to quickly synthesize the information.

Turning to the issued policies information pane 406, a first set of controls 430, 432, 438, and 440 present, upon selection, statistics regarding the cost of aggregate claims. Claims records may be filed through the insurance exchange system and environment, such that the insurance exchange system has access to the claims data to derive aggregate statistics, such as the statistics presented by the “aggregate claims by month” control 430, the “aggregate claims by sector” control 432, the “aggregate claims by plan type” control 438, and the “aggregate claims by geography” control 440. In another example, claims records may be forwarded to the insurance exchange system by the carriers for use in data analysis. Geographical regions, plan types, and employment sectors may be identified as described above in relation to the positive controls 416, 422, and 424. In some implementations, carrier GenericHealth may select the “claims metrics” tab 412c to access more detailed analytics of the aggregate claims data, such as aggregate claims by month and by sector, or average claims by plan type and by geography. Any combination may be possible. Further, the data may be illustrated numerically, in a bar graph, pie chart, line graph, or other visual layout presented to allow carrier GenericHealth to quickly synthesize the information.

A second set of controls 434, 436, 444, and 442 present, upon selection, statistics regarding profit margins based upon the aggregate claims data. Profit margin data, such as statistical data presented upon selection of the “profit margin by month” control 434, the “profit margin by sector” control 436, the “profit margin by plan type” control 442, and the “profit margin by geography” control 444, may only be derived using information private to carrier GenericHealth. To provide carrier GenericHealth with a holistic view of enrollment and policy information through the health insurance carrier dashboard 400, carrier GenericHealth may have previously opted to link in privately held data to manage and coordinate data points from within the insurance exchange system and environment. In another example, the insurance exchange system and environment may provide carrier GenericHealth with a widget, software algorithm, or software application to be installed within the GenericHealth system. The widget, software algorithm, or software application may import statistical information from the insurance exchange system and environment into the GenericHealth system and merge the statistical data with data only available within the GenericHealth system. In this manner, the GenericHealth profit margin data may remain within the GenericHealth system (e.g., protected from access by other entities participating in the insurance exchange system) while incorporating information imported from the insurance exchange system. With this option, for example, the health insurance carrier dashboard 400 is generated within the GenericHealth system (e.g., behind a GenericHealth firewall). Geographical regions, plan types, and employment sectors may be identified as described above in relation to the positive controls 416, 422, and 424. In some implementations, carrier GenericHealth may select the “claims metrics” tab 412c to access more detailed analytics of the profit margin data, such as profit margin by month and by plan type, or profit margin by sector and by geography. Any combination may be possible. Further, the data may be illustrated numerically, in a bar graph, pie chart, line graph, or other visual layout presented to allow carrier GenericHealth to quickly synthesize the information.

Turning to the customer ratings and market demographics data pane 408, a set of controls 446, 448, 450, 452, and 454, when selected, present analytics regarding customer feedback ratings received by the insurance exchange system and environment related to carrier GenericHealth and the plans provided by carrier GenericHealth as well as market demographic information regarding the subscribers of the insurance exchange system and environment who have enrolled with carrier GenericHealth. The ratings, for example, may be based upon a sliding scale, number of stars, or other rating mechanism demonstrating a level of satisfaction a particular subscriber or employer has with a particular carrier or insurance plan. In one example, various aspects of a plan and/or insurance carrier may be rated separately. For example, the insurance exchange system may maintain separate subscriber customer service ratings, employer customer service ratings, subscriber billing ratings, and employer billing ratings related to each insurance carrier. The insurance exchange system, in another example, may maintain separate provider network ratings, plan feature ratings, and economic value ratings associated with each health plan offered by a particular insurance carrier.

The “customer ratings compared to peers” control 446, upon selection, presents an analysis of customer ratings submitted in relation to carrier GenericHealth in comparison to customer ratings submitted in relation to peers of carrier GenericHealth. Peers may be identified as described above in relation to controls 414, 416, 422, and 424. The ratings information, similarly, may be accessed using the “ratings” tab 412e. In presenting the ratings data, separate ratings metrics may be presented based upon employer submissions as opposed to subscriber submissions. The customer ratings may include an overall rating of carrier GenericHealth as well as ratings associated with each plan provided by carrier GenericHealth. Furthermore, ratings data can include detailed ratings and/or review information provided by subscribers or employers, for example in the format of a brief survey. In this manner, aspects of plans, such as customer service responsiveness, accuracy of billing, availability of health providers within the network, and other specific details may be addressed individually. In some embodiments, carrier GenericHealth may conduct individual surveys of subscribers and merge the survey data (e.g., telephone surveys, online surveys, etc.) into ratings data collected by the insurance exchange system. Furthermore, the insurance exchange system and environment may provide carrier GenericHealth the opportunity to share internally collected statistical data with other carriers of the insurance exchange system and environment, thus enriching the information presented via the “customer ratings compared to peers” control 446. The data may be illustrated numerically, in a bar graph, pie chart, line graph, or other visual layout presented to allow the user to quickly synthesize the information.

Controls 448, 450, and 452 relate to risk scores associated with subscribers enrolled in plans with carrier GenericHealth as opposed to subscribers enrolled in plans provided by competitors of carrier GenericHealth. The risk scores, for example, may be determined based upon a carrier-specific algorithm, such that GenericHealth calculates a subscriber's risk score differently than a particular competitor may calculate the risk score. Additionally, a basic risk score value may be applied to each subscriber by the insurance exchange system, for example using a customized algorithm to apply a value that is consistent from carrier to carrier. In selecting the controls 448, 450, and 452, data representing the insurance exchange system risk score may be presented. In another example, data representing comparisons of aggregates of the insurance exchange system risk score between carrier Generic Health and competitors, as well as comparisons of aggregates of the carrier-determined risk scores between carrier Generic Health and competitors are presented. In some implementations, in addition to overall risk score, the averages may include average values of multiple factors contributing to the composition of the enrollment pool's average risk score. For example, a number of factors may contribute to a risk score computation model such as, in some examples, median or average age of subscriber population, gender ratio, race composition, geographic region(s) where the subscribers work or live, employment sector, and medical claims history.

In some implementations, carrier GenericHealth selects the “average risk score, by plan type, compared to peers” control 448 to learn about average risk scores on a plan type basis, in comparison to competitors offering the same plan type. The plan type refers to a variety of plan categories, as described above in relation to control 422.

Carrier GenericHealth selects the “average risk score, by geography, compared to peers” control 450 to access metrics regarding subscriber risk scores broken down by geographical region, in comparison to competitors also competing within a same geographic region. Examples of geographic regions are given above in relation control 424.

Upon selection of the “average risk score, by sector, compared to peers” control 452, the dashboard 400 presents carrier GenericHealth with statistics regarding subscriber risk scores broken down by employment sector, in comparison to competitors also servicing subscribers within the same employment sector. Examples of employment sectors are given above in relation to control 416.

Although illustrated as separate controls 448, 450, and 452, in some implementations, carrier GenericHealth selects the “market demographics” tab 314d to access more detailed analytics of the risk score data, such as risk score by plan type and further by geography. Any combination may be possible. Further, the data may be illustrated numerically, in a bar graph, pie chart, line graph, or other visual layout presented to allow the user to quickly synthesize the information.

The health insurance carrier dashboard 400 presents, upon selection of the “average age and gender, compared to peers” control 454, comparisons of average subscriber demographics (e.g., at least age range and gender) relative to competitors. The age ranges, for example, may include subscriber classifications, such as “infant,” “minor,” “adult,” and “senior citizen.” In another example, age ranges may include age spans of individual subscribers based upon stages of maturity, such as infant (e.g., about 0 to 2), preschool (e.g., about 3 to 5), grade school (e.g., about 6 to 10), junior high (e.g., about 11 to 13), high school (e.g., about 14 to 17), college (e.g., about 18 to 23), early adulthood (e.g., about 24 to 34), on up to retirement (e.g., 64+) and/or geriatric. Other age ranges may be set by even time frames (e.g., 5, 10, or 20 year segments).

The averages by gender and/or age presented in response to selection of the “average age and gender, compared to peers” control 454 may include additional demographic breakdown, such as average by gender and geography, or average by age and employment sector. In some implementations, carrier GenericHealth selects the “market demographics” tab 314d to access more detailed analytics of subscriber pool demographics, such as age by plan type or gender by geography. Any combination may be possible. Further, the data may be illustrated numerically, in a bar graph, pie chart, line graph, or other visual layout presented to allow the user to quickly synthesize the information.

FIG. 4B is a screen shot of an example life insurance carrier dashboard user interface 460 for accessing life insurance carrier information via an insurance exchange system. The dashboard 460 is part of a web site, web portal, personal computer application, or mobile device application configured to allow the carrier (e.g., plan coordinator, actuary, board member, or other corporate official) to interface with the insurance exchange system and environment. As illustrated in the welcome pane 402, carrier “After U R Gone Life Insurance Co.” is connected to the user interface 460.

The dashboard 460 shares the same tabs 412, information panes 404, 406, and 408, and controls 414 through 454 as the dashboard 400 of FIG. 4A. Differences may exist in underlying data, however, due to the nature of life insurance carriers and plans as compared to health insurance carriers and plans. For example, life insurance plan types may include term life insurance and permanent life insurance. Further, term life insurance plans may be broken down into lengths of terms or level, while permanent life insurance may be broken down into whole life, universal life, and variable universal life. Additionally, life insurance plans may be divided by premium levels or premium level ranges.

FIG. 4C is a screen shot of an example disability insurance carrier dashboard user interface 480 for accessing disability insurance carrier information via an insurance exchange system. The dashboard 480 is part of a web site, web portal, personal computer application, or mobile device application configured to allow the carrier (e.g., plan coordinator, actuary, board member, or other corporate official) to interface with the insurance exchange system and environment. As illustrated in the welcome pane 402, carrier “U R Covered Disability Insurance Co.” is connected to the user interface 480.

The dashboard 480 shares the same tabs 412, information panes 404, 406, and 408, and controls 414 through 454 as the dashboard 400 of FIG. 4A. Differences may exist in underlying data, however, due to the nature of disability insurance carriers and plans as compared to health insurance carriers and plans. For example, disability insurance plan types may include individual disability insurance, key-person disability insurance, high-limit disability insurance, business overhead expense (BOE) disability insurance, employer-supplied disability insurance, and worker's compensation. Further, disability insurance plans may be broken down by benefit level or benefit level ranges.

Turning to FIG. 5A, an example environment 500 includes an insurance exchange system 502 for facilitating insurance exchange between a number of insurance carriers 504, employers 506, and individuals 508. Insurance carriers may join the insurance exchange system 502 to advertise available plans to the employers 506 and/or individuals 508. When an employer 506 or individual 508 accesses the insurance exchange system 502, a graphical user interface (GUI) engine 534 may present plan data 542 associated with plans available via the insurance exchange system 502. Through the GUI engine 534, the employers 506 and/or individuals 508 may review plan information and select appropriate plans to meet their needs.

A prospective risk analysis engine 516 and/or a retrospective risk analysis engine 520 develop risk assessment data 556 used to determine aggregated risk (e.g., based upon risk data 552 associated with each employer 506 and/or individual 508) associated with each of the carriers 504. In some implementations, the risk assessment data 556 is based upon particular population data 544 (e.g., geographic region, age range, gender, etc.). In one example, the retrospective risk analysis engine 516 may analyze claims data 538 and/or prescription data 540, accessed from a data store 512, to anticipate future costs based upon past costs. The claims data 538 and/or prescription data 540, for example, may be provided by the insurance carriers 504. The prospective risk analysis engine 516, for example, may review subscriber data 546 (e.g., demographics information regarding individuals 508 who have subscribed to insurance plans through the insurance exchange system 502) as well as, optionally, medical diagnosis information either provided by the individuals 508 or collected from subscriber medical records 510 (e.g., accessible from a cloud server or other secure storage location).

In some implementations, a premium adjustment engine 530 adjusts payments to the insurance carriers 504 according to relative aggregate risk. For example, the amount paid to participating insurance carriers 504 with small aggregated adopted risk may be reduced, and the amount paid to participating insurance carriers 504 with large aggregated adopted risk may be increased. The present premium levels may be stored as premiums data 554. A payment engine 518 may coordinate payments between the employers 506 and/or users 508 and the insurance carriers 504.

A carrier intake and adjustment engine 536, in some implementations, accepts plan data 542 from participating insurance carriers 504. The carrier intake and adjustment engine 536, for example, may classify each plan by a particular plan type, such that individuals 508 and/or employers 506 may review plans by plan type. Initial premiums data 554, in one example, may be developed based upon the identified plan type. An initial risk level, in another example, may be allocated based upon plan type.

In some implementations, a subscriber intake and adjustment engine 532 populates employer data 550 and/or subscriber data 546 regarding new employers 506 and/or individuals 508. Initial risk data 552 associated with new individuals 508 and/or employers 506 may be developed by the prospective risk analysis engine 516. Individuals 508, in some implementations, may link personal medical records 510 with the insurance exchange system 502. The GUI engine 534, upon linking of personal medical records 510, may associate subscriber claims data 538 and/or prescription data 540 with doctor visits, hospital visits, or other activities captured in the medical records 510 and present aggregated information to an individual subscriber 508 for review.

In some implementations, individuals 508 associated with a particular employer 506 are limited to carriers 504 and/or plans 542 selected by the employer 506. In other implementations, individuals 508, although associated with a particular employer 506, are allocated an insurance allowance (e.g., defined contribution) by the employer 506. The defined contribution may be identical for all employees of the employer 506, associated with a particular job category or employee level, or variably linked to a salary level of a particular employee. For example, the insurance exchange system 502 may have access to payroll data from one or more employers 506, used to determine a defined contribution based upon present employee salary. In this manner, as the employee's salary is adjusted, the defined contribution may increase. In some implementations, premiums offered to individuals 508 are priced at a geographic level.

After individuals 508 have joined plans associated with insurance carriers 504, in some implementations, the individuals 508 and/or employers 506 may have the opportunity to rate individual plans and/or submit reviews regarding experiences with the various plans and/or insurance carriers 504. For example, a ratings and review engine 528 may accept ratings data 548 submitted by employers 506 and/or individuals 508. The ratings, for example, may be based upon a sliding scale, number of stars, or other rating mechanism demonstrating a level of satisfaction a particular subscriber 508 or employer 506 has with a particular carrier 504 or insurance plan. In one example, various aspects of a plan and/or insurance carrier 504 may be rated separately. For example, the ratings and review engine 528 may maintain separate subscriber customer service ratings, employer customer service ratings, subscriber billing ratings, and employer billing ratings for each carrier. The ratings and review engine 528, in another example, may maintain separate carrier network ratings, plan feature ratings, and economic value ratings associated with each health plan offered by a particular carrier 504.

Based in part upon the ratings data 548, in some implementations, a recommendation engine 526 may provide recommendations to employers 506 and/or individuals 508 who are reviewing available plans in the insurance exchange system 502. The recommendations, in some implementations, may be based at least in part upon demographic information, diagnostic information, or other similarities between plan subscribers 508 and potential subscribers 508. In presenting recommended plans, the GUI engine 534 may include selected reviews from reviews data 555. The selected reviews, for example, may include reviews associated with subscribers 508 sharing demographic, employer, or medical condition similarities with the potential subscriber 508.

In some implementations, the recommendation engine 526 recommends one or more voluntary products in addition to health insurance plans. For example, dental, vision, life insurance, and/or pet insurance carriers 504 may offer voluntary products via the insurance exchange system 502. Information regarding the voluntary products may be stored as voluntary products data 558 in the data store 512. Similar to the health insurance plans, individuals 508 and/or employers 506 may rate or review the voluntary products via the ratings and review engine 528.

As circumstances change for individuals 508 of the insurance exchange system 502, the subscriber intake and adjustment engine 532 may be used to adjust subscriber data 546. For example, birth, death, adoption, marriage, and divorce may have an effect on a subscriber's interest in a family plan. In one example, a particular subscriber 508 may switch jobs, joining a different employer 506, and wish to retain a present plan. A plan porting engine 522 enables the subscriber 508 to port a present insurance plan to the new employer 506 or to an individual plan (e.g., upon retirement or conversion to independent employment).

In some implementations, a data mining engine 524 derives statistical information, such as pricing statistics 560, cost statistics 562, and/or efficiency statistics 564 from the claims data 538 and/or prescription data 540. The statistical information, for example, may be used to evaluate insurance carriers 504, such as on the basis of relative efficiencies. In a particular example, statistical data regarding insurance carriers is presented within information panes 308, 310, and 312 of the exchange dashboard 300 of FIG. 3. In another example, the statistical information may be used by the prospective risk analysis engine 516, for example to better anticipate future costs based upon cost statistics 562 and/or pricing statistics 560.

In some implementations, aggregated claims data 538 may be shared with the insurance carriers 504. For example, the insurance carriers 504 may use the claims data collected from other insurance carriers 504 to aid in underwriting analysis. The aggregate claims data 538, for example, may correspond to the issued policies information pane 406 of the health insurance carrier dashboard 400 of FIG. 4A (as well as the life insurance carrier dashboard 460 of FIG. 4B and the disability insurance carrier dashboard 480 of FIG. 4C). The statistical data may be collected in a data store 514.

At least a portion of the transactions described above in relation to the insurance exchange system 502 can be performed in real time, while other transactions may be performed in an offline or batch mode operation. For example, transfer of claims data 538 between the insurance carriers 504 and the insurance exchange system 502 may be performed in a batch mode operation. Batch communications can include compression of bulk data, such as the prescription data 540.

In some implementations, the communications between the insurance exchange system 502 and one or more of the insurance carriers 504, employers 506 and individuals 508 are encrypted or otherwise secured. The insurance exchange system 502, in some implementations, performs verification of one or more of the insurance carriers 504, the employers 506, and/or the individuals 508. For example, the insurance exchange system 502 may verify that a particular subscriber 508 is an eligible employee of a particular employer 506.

FIG. 5B is an example environment 570, similar to the example environment 500 but additionally including one or more government exchange systems 572 communicating with the insurance exchange system 502 and/or one or more of the insurance carriers 504. The environment 570 allows individuals 508 (and, optionally, employers 506) to shop for plans within the insurance exchange system 502 while also reviewing plans offered via the federal and/or state exchange.

Insurance carriers 504, in some implementations, opt to license the insurance exchange system 502 to act as a government exchange broker. An external exchange plan intake engine 574, for example, may intake information regarding government exchange-based plans, such as plan data 542 and premiums data 554. When the insurance exchange system 502 acts as a licensed broker, the payment engine 518, ratings and review engine 528, and recommendation engine 526, for example, treat the government exchange plan similarly to any other plan within the insurance exchange system 502. However, because premiums for the government exchange plans are linked to the government exchange systems 572, the premium adjustment engine 530 will not adjust remittance based upon risk assessment data associated with the government exchange plans.

Further, in some implementations, the insurance exchange system 502 provides the insurance carriers 504 and/or government exchange systems 572 to link plan offerings into the insurance exchange system 502. In some implementations, an external exchange rerouting engine 576 may manage linking between the insurance exchange system 502 and the government exchange system 572 through web links or widgets built into user interfaces generated by the GUI engine 534. Upon selection of the linking mechanisms, a user is redirected to a web portal of the selected government exchange system 572. The government exchange systems 572 may provide ratings data 548 and/or reviews data 555 to the insurance exchange system 502 for use by the recommendation engine 526 or the dashboard engine 535 to provide an extra level of comparison for the individuals 508 (and/or employers 506).

While the plan porting engine 522 may be capable of porting government exchange plans when acting as a licensed broker of one of the insurance carriers 504, the plan porting engine 522 will not be able to port plans simply linked into the insurance exchange system 502 through the government exchange systems 572.

In some implementations, the data mining engine 524 derives statistical information such as pricing statistics 560 regarding licensed government exchange plans and/or linked government exchange plans. The statistical information, for example, may be used to evaluate plans offered through the insurance exchange system 502 against plans provided through the government exchange systems 572.

In some implementations, the communications between the insurance exchange system 502 and the government exchange systems 572 are encrypted or otherwise secured. The insurance exchange system 502, in some implementations, establishes a secure communication link (e.g., virtual private network, networking trunk, etc.) to perform real-time linking of information between the insurance exchange system 502 and the government exchange systems 572.

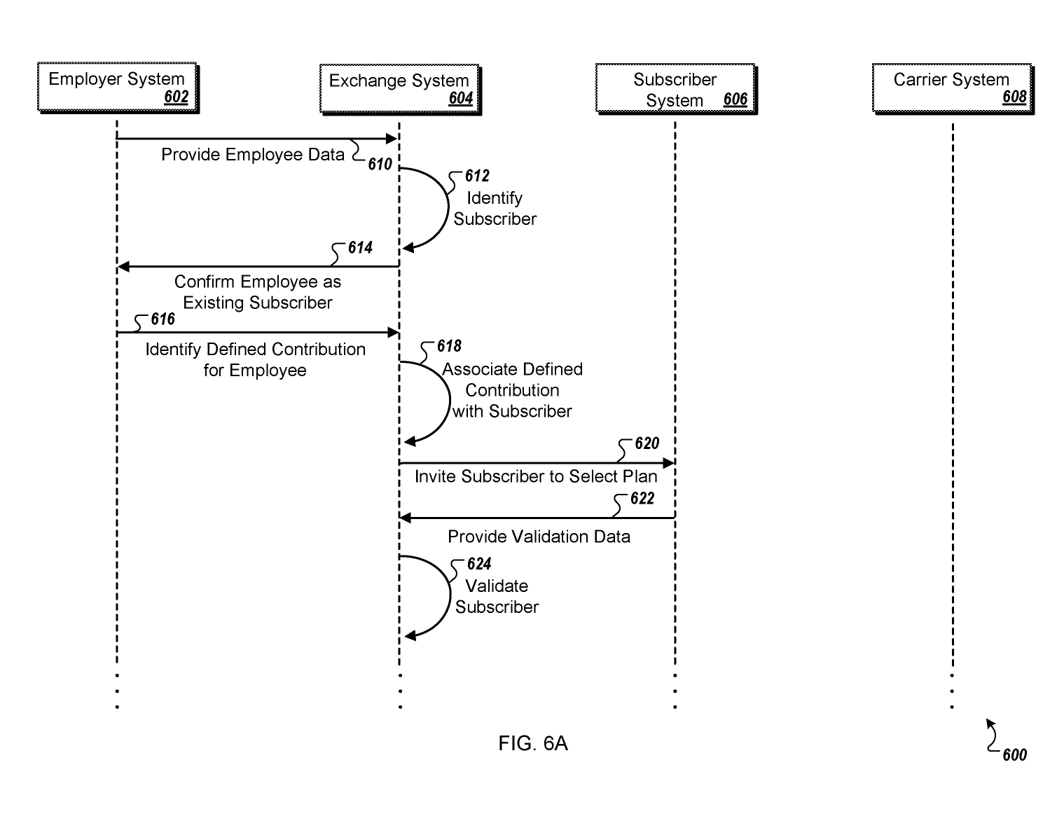

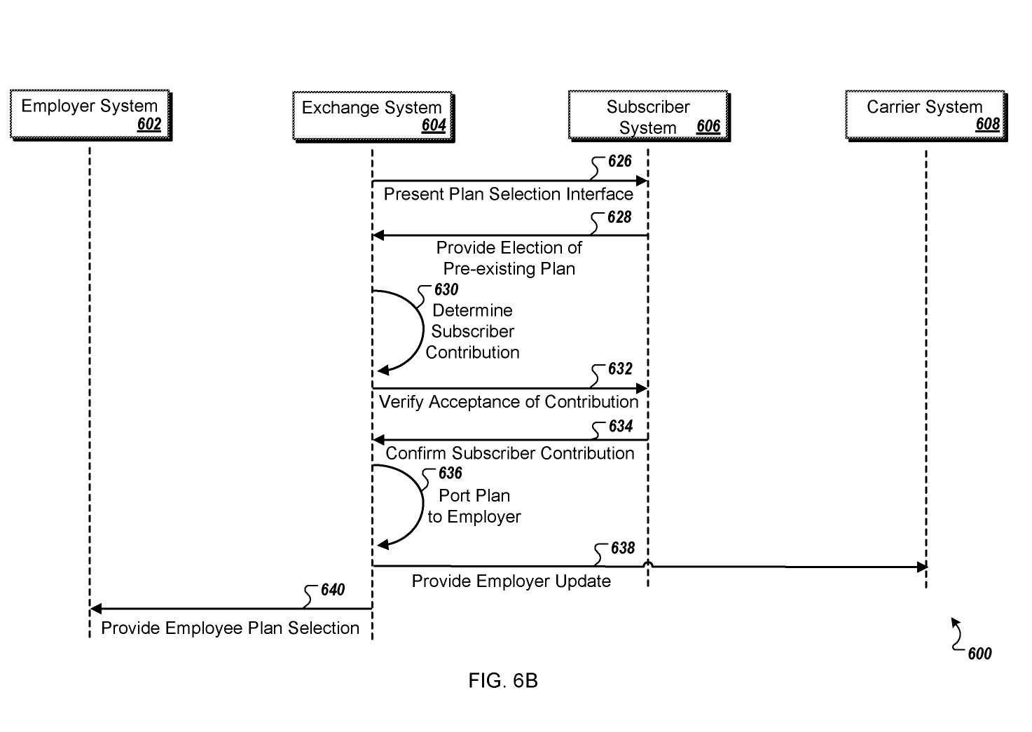

FIGS. 6A and 6B illustrate a swim lane diagram of an example method 600 for porting an insurance plan established by a subscriber via a prior employer to the subscriber's present employer. The method 600, for example, may be performed by the plan porting engine 522, described in relation to FIG. 5. The plan being ported, for example, may be described through a combination including plan data 542 and subscriber data 546, as stored within the data store 512 of FIG. 5A. To port a plan from a prior employer to a present employer or individual plan, an insurance exchange system 604 communicates with an employer system 602 of the new employer, a subscriber system 606 used by the subscriber interacting with the exchange system 604, and an insurance carrier system 608 of the insurance carrier providing the plan.

Turning to FIG. 6A, in some implementations, the method 600 begins with the employer system 602 providing employee data (610) to the exchange system 604. To identify the individual identified within the employee data as a present employee of the employer, for example, the employer system 602 may provide identification data such as name, birth date, social security number, home address and/or phone number. Additionally, in some embodiments, the employer system 602 provides login information for the employee to access the insurance exchange system 604 via the employer system 602. For example, the employer system 602 may provide an employee email address or other unique employee identifier and, optionally, employee password information, such as a default password. In communicating with the exchange system 604, in one example, human resource personnel of the employer may access, via the employer system 602, a web portal provided by the GUI engine 534 of FIG. 5A. In another example, the employer system 602 may provide batch data regarding new hires to the exchange system 604, and the exchange system 604 may intake the new hire data through the subscriber intake and adjustment engine 532 of FIG. 5A.

In some implementations, the exchange system 604 matches the identification data with a preexisting subscriber (612). For example, the subscriber intake and adjustment engine 532 may access the data store 512 to match the employee identification data with subscriber data 546, as illustrated in FIG. 5A.

In some implementations, the exchange system 604 issues a confirmation to the employer system 602, confirming that the employee data matches an existing subscriber (614). For example, the subscriber intake and adjustment engine 532 may present, via a user interface provided by the GUI engine 534, a confirmation regarding the existence of a subscriber matching the employee identification data. In some embodiments, if a portion of the identification data fails to match the stored subscriber data 546, the subscriber intake and adjustment engine 532 may confirm with the employer system 602 that the mismatched information (e.g., address, telephone number, etc.) should be updated to reflect the new information provided by the employer system 602.

Additionally, if the employer funds insurance plans via defined contribution, in some implementations, the employer system 602 provides the exchange system 604 with identification of a defined contribution associated with the employee (616). The identification, in some examples, may include a dollar amount or employee category. In another example, the identification of the defined contribution may include a payroll identifier that can be used by the exchange system 604 to access a payroll system of the employer, linking the present salary of the employee as accessed via the payroll system to a defined contribution level.

In some implementations, the exchange system 604 associates the defined contribution with the subscriber (618). For example, the subscriber intake and adjustment engine 532 of FIG. 5A may update the subscriber data 546 with the defined contribution information provided by the employer via the employer system 602.

If the employer system 602 provided an employee email address for the subscriber, in some implementations, the insurance exchange system 604 issues an invitation (620) to the employee to select a plan via the exchange system 604. The employee accesses the invitation via the subscriber system 606. In other implementations, rather than issuing an invitation through the exchange system 604, the employer system 602 provides access instructions directly to the employee.

In some implementations, the employee, via the subscriber system 606, provides validation data (622) to the exchange system 604 to validate the employee as a subscriber of the exchange system 604. Note that, although illustrated as separate systems for sake of clarity, in some implementations, the subscriber, via the subscriber system 606 (e.g., personal computer, tablet PC, or other computing device) accesses a web portal supplied by the employer system 602 to communicate with the exchange system 604. The validation data, in some examples, can include a user name or employee email address as well as a password or default identification information (e.g., social security number).

In some implementations, the exchange system 604 validates the subscriber (624) using the supplied validation data. In this manner, for example, the health exchange system 604 may guard against unauthorized access to subscriber data. A number of security measures may be employed to validate the participate system 606 with the exchange system 604.

Turning to FIG. 6B, in some implementations, the exchange system 604 presents a plan selection interface (626) to the subscriber system 606. For example, the GUI engine 534 of FIG. 5A may present plan options to the employee. The plan options, in one example, may include various plans recommended by the employer as well as the subscriber's plan established with the prior employer. In another example, the exchange system 604 may simply confirm that the employee would like to continue on the present plan, rather than presenting additional options immediately.

In some implementations, the employee, via the subscriber system 606, issues an election (628) to the exchange system 604 of the pre-existing plan. For example, via a graphical user interface, the employee may click on or otherwise select the pre-existing plan.

In some implementations, the exchange system 604 determines a subscriber contribution towards the premium associated with the pre-existing plan (630). If the employer supplied a defined contribution, for example, the exchange system 604 determines the premium based upon the defined contribution. If, instead, the employer is the plan purchaser, the exchange system 604 determines the employee contribution associated with the particular employer. In determining the subscriber contribution, if the employee has relocated geographically, the exchange system 604 may adjust the premium based upon present demographic information. For example, the premium adjustment engine 530 may determine a premium associated with the employer's geographic location or the geographic location of a branch where the subscriber is employed.

In some implementations, the exchange system 604 presents the subscriber, via the subscriber system 606, with information to prompt verification of acceptance of the contribution (632). The contribution, for example, may have changed between the previous employer and the present employer. Furthermore, the exchange system 604 may present the subscriber, if applicable, the defined contribution amount designated by the employer system 602. In this manner, the employee can verify that the human resources information was entered into the exchange system 604 correctly.

In some implementations, the employee confirms acceptance of the subscriber contribution (632) via the subscriber system 632, by issuing a confirmation to the exchange system 604. For example, the employee may click an accept button designating that the subscriber contribution may be deducted from the employee's paycheck by the employer system 602. Conversely, the employee may enter billing information such as a credit card number for payment of the balance due. Furthermore, the employee may be presented with a variety of payment options, such as monthly billing, weekly billing, or quarterly billing. The payment engine 518 of FIG. 5A, for example, may manage the employee contribution payments. In another example, the exchange system 502 of FIG. 5A may communicate with the payroll system of the employer 506 to establish automatic deduction of the employee contribution.

In some implementations, the exchange system 604 ports the pre-existing insurance plan to the new employer (636). For example, the plan porting engine 522 of FIG. 5A may port the information from the former employer to the new employer or to an individual plan. Porting of the plan, for example, includes adjusting subscriber information in the data store 512 to link the plan data 542 associated with the particular subscriber data 546 to the new employer data 550. Further, the new employer data 550 may be adjusted to identify pre-existing claims data 538 or prescription data 540. The pre-existing claims data 538 or prescription data 540, for example, may be mined to identify ongoing expenses corresponding to the employee's selected plan.

In some implementations, the exchange system 604 provides information regarding the employer update (638) to the carrier system 608. For example, the carrier may be alerted that the plan has been shifted to the employer system 602. Furthermore, in some embodiments, any adjustments to the selected plan, such as a premium adjustment based upon a regional relocation of the employee, may be provided to the carrier system 608. Although, as illustrated, it appears that the exchange system 604 is pushing information to the carrier system 608, in some embodiments, the carrier system 608 may establish a communication link with the exchange system 604, such as on a periodic basis, to retrieve updated information regarding plan selections. Further, in some implementations, the carrier may access information regarding present plans via the enrollment information pane 404 of the carrier dashboard 400, 460, or 480 as described in relation to FIGS. 4A through 4C.

In some implementations, the exchange system 604 provides information regarding the subscriber's plan election (640) to the employer system 602. For example, if the subscriber has an employee contribution amount, the exchange system 604 may provide the employer system 602 with information required to update the payroll system to make the necessary deductions. Conversely, if the subscriber selected a plan that costs less than the employer's defined contribution, the exchange system 604 may provide the employer system 602 with information regarding a surplus remainder in defined contribution.

Although described in relation to an insurance plan, in some implementations, the subscriber is provided the opportunity to port one or more voluntary products, depending upon whether the voluntary products are covered under the new employer. For example, the subscriber, in addition to porting a health insurance plan, may port a dental insurance plan. In other implementations, the certain steps of the method 600 may be performed in a different order. For example, in some implementations, the subscriber contribution may be determined (630) prior to presenting the plan selection interface (626). One or more steps of the method 600, in further implementations, may be removed or added.

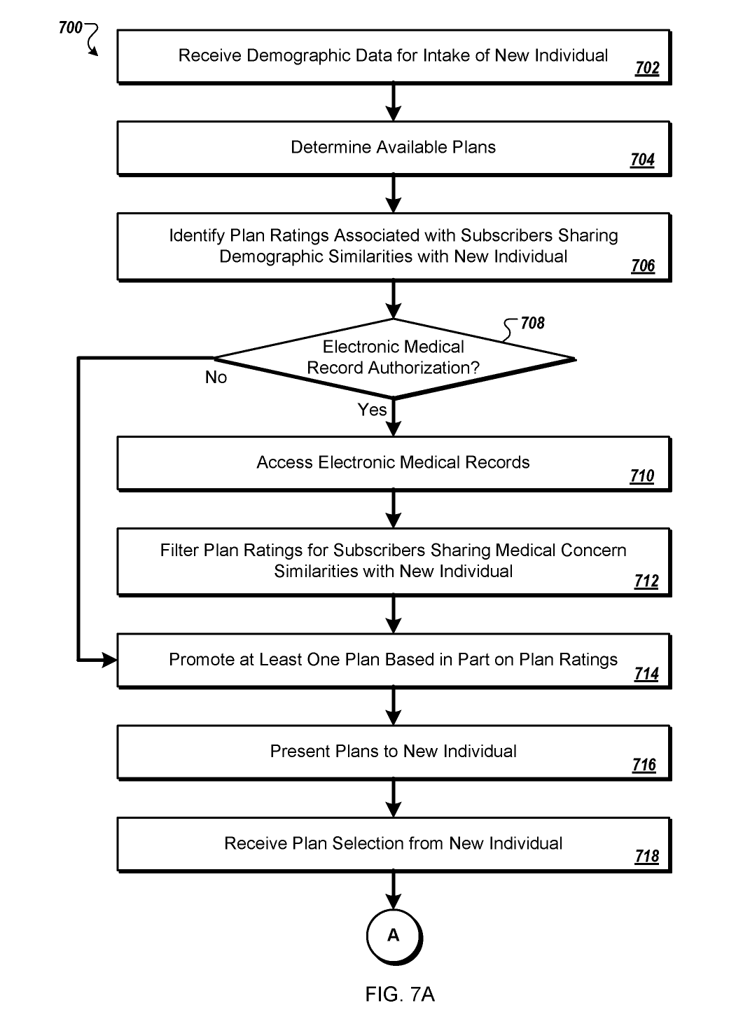

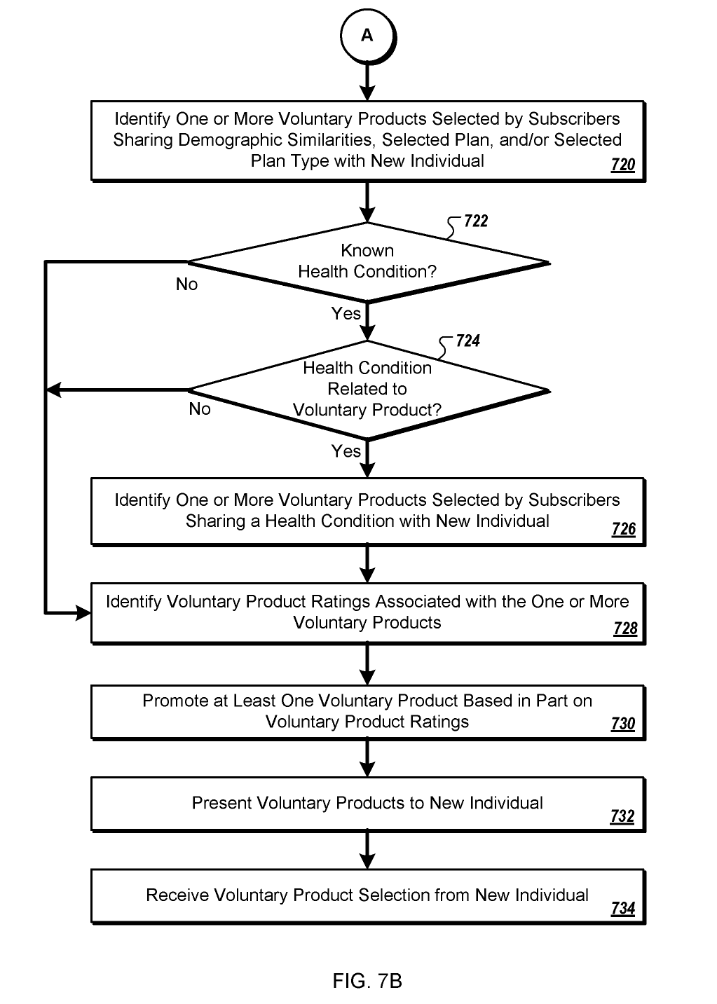

FIGS. 7A and 7B illustrate a flow chart of an example method 700 for presenting a potential subscriber with plan and voluntary product information based in part on ratings data collected from other subscribers in an insurance exchange system. The ratings and review engine 528 of FIG. 5A may collect and organize ratings data 548 and reviews data 555 used by the recommendation engine 526 to present recommended plans and/or voluntary products to a subscriber 508. The information regarding insurance plans, for example, may be presented to the potential subscriber in the “my health plan” tab 116b of the subscriber dashboard 100 of FIG. 1. For example, the method 700 may be launched upon selection, by the potential subscriber, of the “health plan” navigational control 114a.

In some implementations, the method 700 begins with receiving demographic data for intake of a new individual in an insurance exchange system (702). The demographic data, for example, may include subscriber data 546 illustrated in FIG. 5A such as, in some examples, age, gender, geographic region, family structure (e.g., spouse or domestic partner, number of children, etc.), and career category. At least a portion of the demographic data may be entered into the system by an employer 506 of the new individual 508, for example as part of the human resource intake process. Further, in some embodiments, the individual 508 may enter a portion of the demographic information, for example during initial registration as a new subscriber of the exchange system 502.

In some implementations, available plans are determined (704). The available plans, for example, may include plans pre-selected by an employer of the individual. In another example, the available plans may be identified based upon a demographic region of the individual. In further examples, the available plans may be limited to plans fitting criteria supplied by the individual, such as plans having a premium within a budget designated by the individual or plans including a number of desired features identified by the individual.

In some implementations, plan ratings associated with at least one of the available plans, submitted by subscribers sharing demographic similarities with the new individual, are identified (706). Subscriber demographic data associated with plan ratings may be cross-referenced against the new individual demographic data to identify one or more similarities. The similarities may include, in some examples, an age range, geographic region, gender, family status, and/or ethnicity. In other example, any ratings provided by subscribers having a threshold demographic similarity (e.g., 15%, 20%, or 30% similar, etc.) with the new individual are identified. Rather than or in addition to correlating stored demographic information regarding subscribers, demographic information may be derived from text submitted in a review corresponding to a rating. For example, in identifying ratings submitted by parents of newborns, the text of a review may be culled for terms such as “infant”, “newborn”, or “baby.”

In some implementations, if the new individual authorizes electronic medical record access (708), the individual's electronic medical records are accessed (710). For example, as described in relation to FIG. 5A, the insurance exchange system 502 may access medical records 510 from an external repository. Depending upon local privacy law and/or subscriber privacy settings, a portion of the data may be available for access by the exchange system 502 to enrich recommendations.

In some implementations, the identified plan ratings are filtered to identify ratings associated with subscribers sharing medical concern similarities with the new individual (712). The medical concerns, in one example, may be identified within electronic medical record data of the existing subscribers. In another example, the medical concerns may be derived (or implied) from prescription data 540 and/or claims data 538. Further, some medical concerns may have been supplied by subscribers, for example upon registering with the insurance exchange system. In one example, chronic medical issues (e.g., diabetes, asthma, arthritis, etc.) may be identified within the electronic medical record data and compared to medical concerns of subscribers who submitted the identified plan ratings. In another example, preferred treatment methods (e.g., chiropractic, acupuncture, physical therapy, etc.) derived from the electronic medical records of the new individual may be compared to preferred treatment methods of the subscribers who submitted the identified plan ratings. The recommendation engine 526 illustrated in FIG. 5A, for example, may review ratings to identify subscribers sharing medical concerns with the new individual. Rather than or in addition to correlating stored medical concern information regarding subscribers, medical concern “buzz words” may be identified within text submitted in a review corresponding to a rating. For example, in identifying ratings submitted by those suffering from osteoporosis, the reviews may be culled for the term “osteoporosis” as well as, in some examples, “bone density”, “bone mineral density”, BMD, SIOP, “preosteoporosis”, and/or “osteopenia.”

Rather than filtering the previously identified plan ratings to identify plan ratings associated with subscribers sharing medical concerns with the new individual, in other implementations, plan ratings associated with at least one of the available plans, submitted by subscribers sharing medical concern similarities with the new individual, may be identified. For example, if the new individual has a rare medical concern, limiting the scope to ratings which also share demographic similarities with the new subscriber may prove to be too limiting. The recommendation engine 526, in some embodiments, may expand the review scope when limiting to only those ratings sharing demographic similarities results in less than a threshold number of results.

In some implementations, at least one of the available plans is promoted based in part upon the identified plan ratings (714). For example, the recommendation engine 526 of FIG. 5A may aggregate identified ratings to determine a highest rated plan in light of subscribers most similar to the new individual. Additionally, the remaining plans may be ranked according to relative ratings. The promotion or ranking, for example, may effect presentation of the information to the new individual.

In some implementations, the available plans are presented to the new individual (716). The plans, for example, may be arranged in order from top to bottom of the page in relative ratings rank. In another example, the plans may be arranged in order from left to right across the page in relative ratings rank. The plan with the highest adjusted rating, in a third example, may be surrounded by a colorful box or otherwise highlighted in relation to the additional available plans. The adjusted ratings value(s), in one example, may be presented to the new individual. Furthermore, one or more reviews selected in relation to the ratings may be presented or made available to the new individual.

In some implementations, a plan selection is received from the new individual (718). The new individual, upon reviewing the available plans, may select a plan. For example, the new individual may click on the plan, call a telephone number associated with the insurance exchange and make an oral selection, or mail in a selection (e.g., via paperwork filled out and filed by the human resource department of the new individual's employer).

Although described in relation to a new subscriber, in some implementations, a similar method may be used to present a current subscriber with information for changing plans. A subscriber may change a plan, for example, due to a change in employment or a change in family status. The method 700, in this manner, may be executed upon selection of the “compare to available coverage” control 138a of the subscriber dashboard 100, described in relation to FIG. 1.

FIG. 7B presents an additional section of the method 700 pertaining to marketing voluntary products to a new individual in addition to the elected plan. A set of most applicable voluntary products to the lifestyle and health concerns of the new individual, for example, may be identified based in part upon reviewing selections made by other subscribers identified as sharing similarities with the new individual. The steps illustrated in FIG. 7B, in some embodiments, are performed along with health plan election (e.g., prior to confirmation of election or while the new individual is reviewing plan options). In other embodiments, the steps illustrated in FIG. 7B are performed after the new individual has finalized a health insurance plan election (e.g., become a subscriber). The order and scope of the steps illustrated in FIG. 7B may alter depending upon the use of the promotion and marketing of voluntary products in the insurance exchange system.

Turning to FIG. 7B, in some implementations, one or more voluntary products selected by subscribers sharing similarity in demographic(s), similarity in selected plan, and/or similarity in selected plan type with the new individual are identified (720). For example, based upon the plan and/or plan type, the plan may be lacking a desirable feature that may be provided by a voluntary product, such as vision insurance and/or dental insurance. The desirability of these features may vary based upon demographics, such as age range or family composition. For example, the parent of a child within the age range of the need for braces may be more likely to want dental insurance. In some implementations, subscriber demographic data associated with voluntary product elections are cross-referenced against the new individual demographic data to identify one or more similarities. The similarities may include, in some examples, an age range, geographic region, gender, family status, and/or ethnicity. In other example, any ratings provided by subscribers having a threshold demographic similarity (e.g., 15%, 20%, or 30% similar, etc.) with the new individual are identified. The recommendation engine 526 described in relation to FIG. 5A, for example, may identify voluntary products.

In some implementations, if the new individual or a family member of the new individual has a known health condition (722) that is determined to be related to a voluntary product (724), one or more voluntary products selected by subscribers sharing the health condition with the new individual (or family member thereof) are identified (726). For example, if the new individual has gum disease, a dental plan selected by those with gum disease may be identified.

In some implementations, voluntary product ratings associated with the one or more voluntary products are identified (728). The recommendation engine 526 illustrated in FIG. 5A, for example, may access product ratings for the one or more voluntary products. Furthermore, in some embodiments, the product ratings may be filtered to include only those submitted by subscribers share demographics, plan type, or plan election with the new individual.

In some implementations, at least one of the voluntary products is promoted based in part upon the identified voluntary product ratings (730). In one example, the recommendation engine 526 of FIG. 5A may identify the most commonly selected voluntary product by subscribers sharing demographics, plan type, or plan election with the new individual. In another example, the recommendation engine 526 of FIG. 5A may aggregate identified ratings to determine a highest rated voluntary product in light of subscribers most similar to the new individual. Additionally, the remaining voluntary products may be ranked according to relative ratings and/or relative popularity.

In some implementations, the voluntary products are grouped by product type prior to promotion. For example, the recommendation engine 526 of FIG. 5A may compare various available dental plans separately from various available vision plans.

One or more voluntary product types, in some implementations, may be offered by the employer of the new individual as part of a benefits package. For example, the new individual may receive partial or full contribution towards a dental plan premium. In this case, the voluntary product type(s) offered by the employer may be promoted in relation to other voluntary products available to the new individual. In one example, information regarding employer contribution may be highlighted in relation to a particular voluntary product, such as pet insurance. In this manner, the employer may market the benefits offering to employees through the insurance exchange.

In some implementations, the recommended voluntary products are presented to the new individual (732). The voluntary products, for example, may be grouped according to type (e.g., disability insurance, pet insurance, dental insurance, vision insurance, etc.), with a particular product within each group highlighted or promoted in relation to additional voluntary product options, if applicable. The adjusted ratings value(s), in one example, may be presented to the new individual. Furthermore, one or more reviews selected in relation to the ratings may be presented or made available to the new individual.

In some implementations, a voluntary product selection is received from the new individual (734). The new individual, upon reviewing the available voluntary products, may select a voluntary product. For example, the new individual may click on the voluntary product, call a telephone number associated with the insurance exchange and make an oral selection, or mail in a selection (e.g., via paperwork filled out and filed by the human resource department of the new individual's employer).

In other implementations, the certain steps of the method 700 may be performed in a different order. For example, in some implementations, the ratings associated with subscribers sharing medical concern similarities with the new individual (712) may be identified prior to filtering for plan ratings associated with subscribers sharing demographic similarities with the new individual (706). One or more steps of the method 600, in further implementations, may be removed or added.

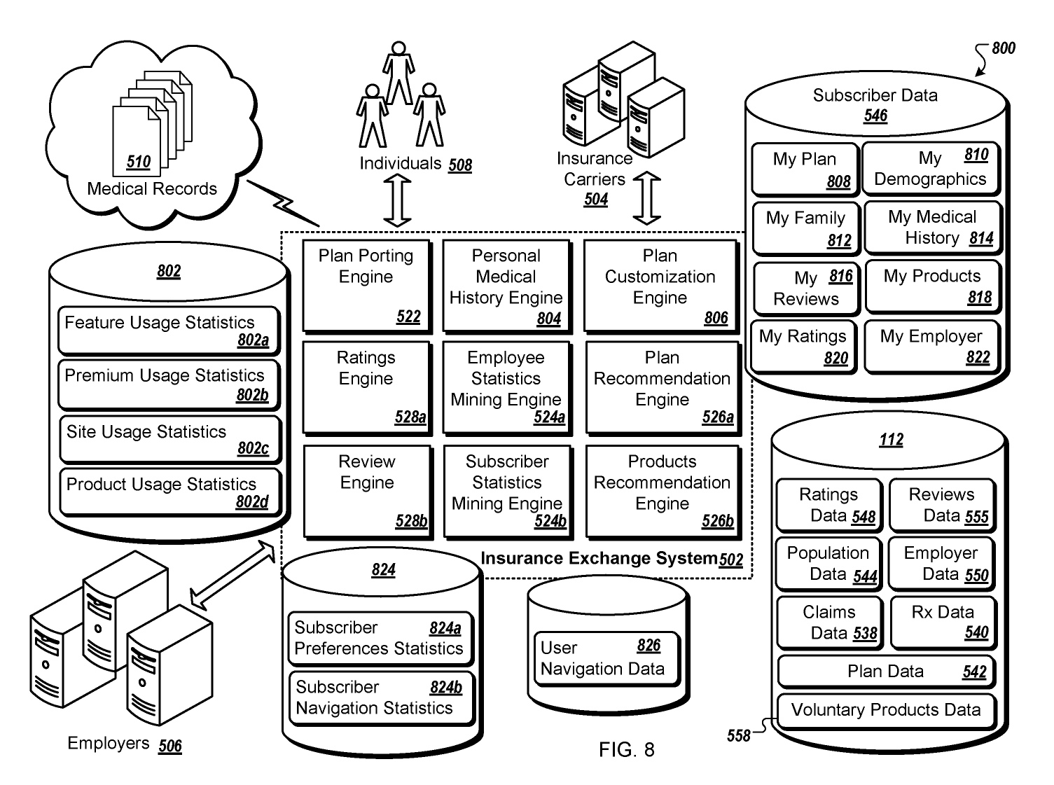

FIG. 8 is a block diagram of an example environment 800 for personalizing the insurance exchange system 502 experience for both employers 506 and individuals 508. The environment 800, as compared to the environment 500 of FIG. 5A, includes enhanced subscriber data 546 identifying various subscriber information tracked by the insurance exchange system 502, employee usage statistics 802 derived by an employee statistics mining engine 524a and subscriber statistics mining engine 524b for providing employers 506 with insight towards employee usage of the insurance exchange system 502, and a plan customization engine 806 to support customization of employer offerings based in part upon the employee usage statistics 802 as well as, in some circumstances, more general subscriber preferences derived by a subscriber statistics mining engine 524b. The statistics information, for example, may be presented to users (e.g., carriers, subscribers, and employers) in dashboard form via a dashboard engine 535. The dashboard engine 535, for example, may present the information illustrated in FIGS. 1 through 4.

The environment 800, in some implementations, uses enhanced subscriber data 546 to provide greater features and flexibility to individuals 508. For example, subscriber data 546 is used by a personal medical history engine 804 to combine data from electronic medical records 510 with subscriber claims data 538 and/or subscriber prescription data 540 to present individuals 508 with a personalized medical history portal graphically illustrating subscriber medical history data 814. In another example, the plan porting engine 522 can port subscriber plan data 808 from a prior employer to the present employer data 822 or to an individual plan. The subscriber data 546 lends to statistical analysis provided to subscribers, such as comparisons of health issues (e.g., “compare your averages for your age, gender, and race” control 124 of the subscriber dashboard 100 of FIG. 1) or risk scores (e.g., “compare to averages for your age, gender, and race” control 132 of the subscriber dashboard 100). Furthermore, the subscriber data 546 lends to statistics available via the “employees and medical histories” information pane 204 and/or the “risk score” information pane 206 of the employer dashboard 200 of FIG. 2. The “group and individual data” information pane 302 of the exchange dashboard 300 of FIG. 3, in another example, provides access to various subscriber data 546. Furthermore, the “customer ratings and market demographic data” pane 408 of the insurance carrier dashboards 400, 460, and 480 of FIGS. 4A through 4C includes access to statistics derived from the subscriber data 546.

A ratings engine 528a enables individuals 508 to submit ratings regarding plans and/or voluntary products, while a reviews engine 528b enables individuals 508 to submit reviews regarding the same. The resultant reviews data 555 and ratings data 548 is accessed by both a plan recommendation engine 526a and a products recommendation engine 526b to enhance subscriber selection of plans and voluntary products within the insurance exchange system 502. For example, the plan recommendation engine 526a can customize plan option presentation for a subscriber based upon ratings and reviews of other individuals 508 similar to the subscriber, as described in relation to FIG. 7A, while a products recommendation engine 526b can customize voluntary products option presentation for a subscriber based upon selections, ratings, and reviews of other similar individuals 508, as described in relation to FIG. 7B. Furthermore, statistical analysis of the plan ratings, derived by the subscriber statistics mining engine 524b, lends data to the subscriber dashboard 100 of FIG. 1 (e.g., via the “other carriers by user rating” control 136), the employer dashboard 200 of FIG. 2 (e.g., via the “ratings of current plans relative to peers” control 240), and the exchange dashboard 300 of FIG. 3 (e.g., via the “plan ratings by sector, region” control 338). Furthermore, the ratings data statistics are important to the carriers 504, as demonstrated by the “customer ratings compared to peers” control 446 of carrier dashboards 400, 460, and 480.

The interactions of individuals 508 with the insurance exchange system 502 are logged as various subscriber data 546, such as subscriber plan 808 (e.g., linking to plan data 542), subscriber demographics 810 (e.g., categorized in part by population data 544), subscriber family data 812 (e.g., linking a present subscriber with additional individuals 508 of the insurance exchange system 502), subscriber medical history 814 (e.g., including information derived from electronic medical records 510, claims data 538, and/or prescription data 540), subscriber reviews 816 (e.g., linking to reviews data 555), subscriber ratings 810 (e.g., linking to ratings data 548), subscriber products 818 (e.g., linking to one or more voluntary products 558), and subscriber's employer 822 (e.g., identifying one of the employers 550).

The employee statistics mining engine 524a mines subscriber data 546 to identify trends in employee usage of the insurance exchange system 502. Feature usage statistics 802a, derived by the employee statistics mining engine 524a, maps claims data 538 of employees of a particular employer 506 to features and/or feature subsets of plans to identify “hot spots” in plan use. For example, employees of a particular employer 506 may make great use of health club membership reimbursement but rarely take advantage of mail order pharmaceuticals. Similarly, the employee statistics mining engine 524a may generate product usage statistics identifying most popular products or product types. In this manner, an employer 506 may determine which voluntary products to offer as partially or fully funded employee benefits. Premium usage statistics 802b, derived by the employee statistics mining engine 524a, track claims data 538 in comparison to premium payments made by the employer 506 to demonstrate spikes and lulls in employee medical costs over time. Site usage statistics 802c, derived by the employee statistics mining engine 524a, identifies site features commonly utilized by employees. For example, an employer 506 may wish to determine whether to purchase premium site usage with personal medical history portal capability (e.g., provided by the personal medical history engine 804).

In some implementations, the plan customization engine 806 generates customized offerings for employer benefits based upon trends derived from the employee statistics 802. For example, the plan customization engine 806 may promote the most popular features and products, as identified by the feature usage statistics 802a and product usage statistics 802d, as best options. In another example, the plan customization engine 806 may recommend downgrading to a less expensive plan as a replacement for a more expensive plan should the plan customization engine 806 determine that one or more features of the more expensive plan are rarely if ever used by the employees of a particular employer 506 (e.g., via the feature usage statistics 802a). Additionally, site features may be promoted based upon anticipated use, for example by demonstrating that employees of similar employers take advantage of the personal medical history portal provided by the personal medical history engine 804.

The employee statistics mining engine 524a, in some implementations, mines employee data, such as demographics data 810, medical history data 814, claims data 538, and prescription data 540 to analyze risk factors in individual employees and/or groupings of employees. The risk factors, for example, may contribute to the risk scores discussed in relation to risk data 552, risk assessment data 556, and risk analysis engines 516, 520 of FIG. 5A. The employers 506 may contribute additional data for analysis, such as absenteeism data, health screening data (e.g., obtained through employer sponsored health events), and/or data regarding employee participation in employer-sponsored wellness programs. Through analysis of health and wellness data associated with employees, employers may gain insight into potential avenues (e.g., employer sponsored programs, voluntary products, workplace improvements, etc.) for improvement in the health and well-being of the employee base. The employers 506 may further provide salary information for inclusion in the analysis to contribute to overall cost analysis associated with the risk factors (e.g., absenteeism as well as medical claims and prescription costs). The analysis may be tracked over time and/or compared to peers of an individual employer to provide employers 506 with insight into risk reduction achieved through implementation of improvements (e.g., employer sponsored wellness programs, etc.).

The subscriber statistics mining engine 524b, in some implementations, mines subscriber data 546 to identify trends in subscriber usage of the insurance exchange system 502. Insurance carriers 504, for example, may review subscriber preferences statistics 824a, generated by the subscriber statistics mining engine 524b, to customize plan offerings based upon preferred features. In some embodiments, the plan customization engine 806 may recommend new or updated plan offerings to the carriers 504 based upon subscriber preferences statistics 824a. For example, as described above in relation to feature usage statistics 802a, general subscriber feature usage statistics may map claims data 538 of individuals 508 to features and/or feature subsets of plans to identify “hot spots” in plan use. This information, for example, may be presented to personnel of the insurance exchange system within the market data tab 314d of the exchange dashboard 300 of FIG. 3.

The subscriber statistics mining engine 524b, in some implementations, mines subscriber navigation data 826 to identify usage trends of a web portal feature of the insurance exchange system 502. The insurance exchange system 502, for example, may modify navigation paths of the web portal based upon review of subscriber navigation data 82b to make the web portal as user-friendly as possible. Furthermore, insurance carriers 504 may review subscriber navigation statistics 824b to identify commonly reviewed plan information to identify most important features to subscribers in making plan selections.

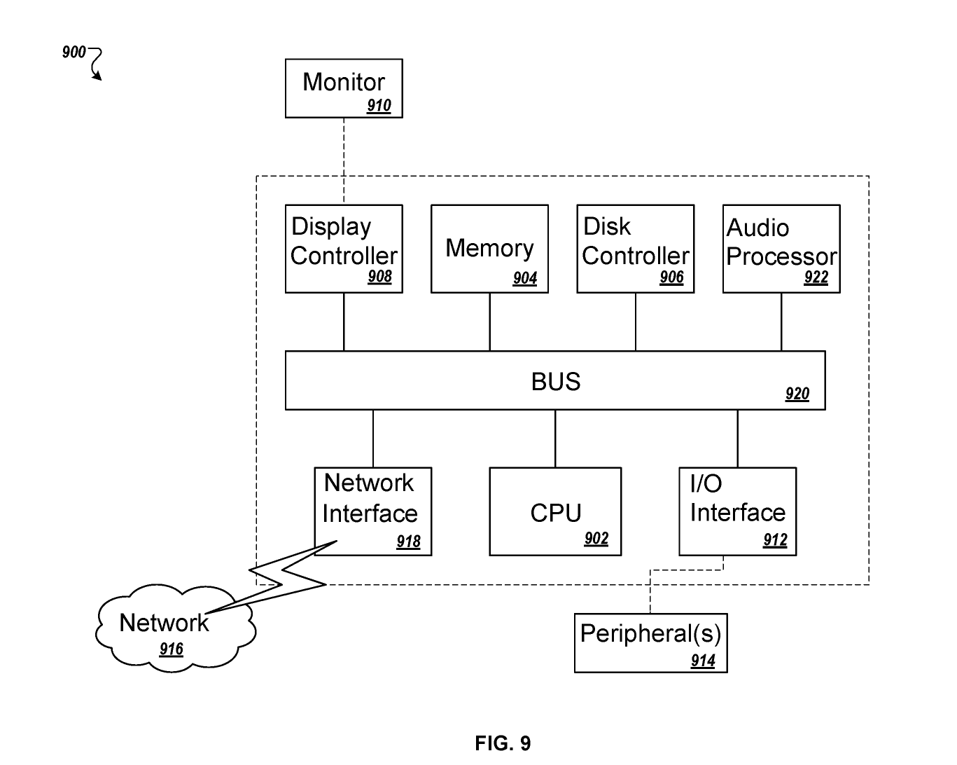

FIG. 9 illustrates an example processing system 900, and illustrates example hardware found in a controller or computing system (such as a personal computer, i.e., a laptop or desktop computer, which can embody a workstation, server, personal computer, or other computing device according to this disclosure) for implementing and/or executing the processes, algorithms and/or methods described in this disclosure. The processing system 900 in accordance with this disclosure can be implemented in one or more the components shown in FIG. 1. One or more processing systems can be provided to collectively and/or cooperatively implement the processes and algorithms discussed herein.

As shown in FIG. 9, the processing system 900 in accordance with this disclosure can be implemented using a microprocessor 902 or its equivalent, such as a central processing unit (CPU) and/or at least one application specific processor ASP (not shown). The microprocessor 902 is a circuit that utilizes a computer readable storage medium 904, such as a memory circuit (e.g., ROM, EPROM, EEPROM, flash memory, static memory, DRAM, SDRAM, and their equivalents), configured to control the microprocessor 902 to perform and/or control the processes and systems of this disclosure. Other storage mediums can be controlled via a controller, such as a disk controller 906, which can controls a hard disk drive or optical disk drive.

The microprocessor 902 or aspects thereof, in alternate implementations, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The microprocessor 902 can be a separate device or a single processing mechanism. Further, this disclosure can benefit from parallel processing capabilities of a multi-cored CPU.

In another aspect, results of processing in accordance with this disclosure can be displayed via a display controller 908 to a display device (e.g., monitor) 910. The display controller 908 preferably includes at least one graphic processing unit, which can be provided by a number of graphics processing cores, for improved computational efficiency. Additionally, an I/O (input/output) interface 912 is provided for inputting signals and/or data from microphones, speakers, cameras, a mouse, a keyboard, a touch-based display or pad interface, etc., which can be connected to the I/O interface as a peripheral 914. For example, a keyboard or a pointing device for controlling parameters of the various processes and algorithms of this disclosure can be connected to the I/O interface 912 to provide additional functionality and configuration options, or control display characteristics. An audio processor 922 may be used to process signals obtained from I/O devices such as a microphone, or to generate signals to I/O devices such as a speaker. Moreover, the display device 910 can be provided with a touch-sensitive interface for providing a command/instruction interface.

The above-noted components can be coupled to a network 916, such as the Internet or a local intranet, via a network interface 918 for the transmission or reception of data, including controllable parameters. A central BUS 920 is provided to connect the above hardware components together and provides at least one path for digital communication there between.

One or more processors can be utilized to implement any functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

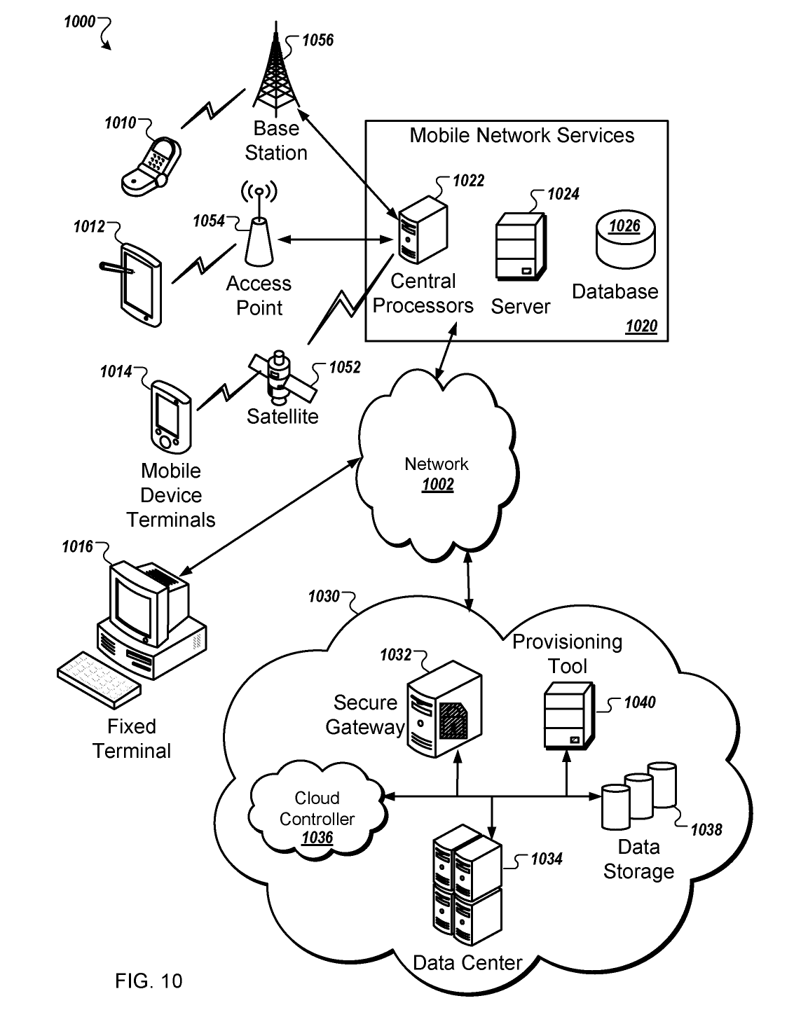

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 10, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, the described herein may interface with a cloud computing environment 1030, such as Google Cloud Platform™ to perform at least portions of methods or algorithms detailed above. The processes associated with the methods described herein can be executed on a computation processor, such as the Google Compute Engine by data center 1034. The data center 1034, for example, can also include an application processor, such as the Google App Engine, that can be used as the interface with the systems described herein to receive data and output corresponding information. The cloud computing environment 1030 may also include one or more databases 1038 or other data storage, such as cloud storage and a query database. In some implementations, the cloud storage database 1038, such as the Google Cloud Storage, may store processed and unprocessed data supplied by systems described herein.

The systems described herein may communicate with the cloud computing environment 1030 through a secure gateway 1032. In some implementations, the secure gateway 1032 includes a database querying interface, such as the Google BigQuery platform.

The cloud computing environment 1002 may include a provisioning tool 1040 for resource management. The provisioning tool 1040 may be connected to the computing devices of a data center 1034 to facilitate the provision of computing resources of the data center 1034. The provisioning tool 1040 may receive a request for a computing resource via the secure gateway 1032 or a cloud controller 1036. The provisioning tool 1040 may facilitate a connection to a particular computing device of the data center 1034.

A network 1002 represents one or more networks, such as the Internet, connecting the cloud environment 1030 to a number of client devices such as, in some examples, a cellular telephone 1010, a tablet computer 1012, a mobile computing device 1014, and a desktop computing device 1016. The network 1002 can also communicate via wireless networks using a variety of mobile network services 1020 such as Wi-Fi, Bluetooth, cellular networks including EDGE, 3G and 4G wireless cellular systems, or any other wireless form of communication that is known. In some embodiments, the network 1002 is agnostic to local interfaces and networks associated with the client devices to allow for integration of the local interfaces and networks configured to perform the processes described herein.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, some implementations may be performed on modules or hardware not identical to those described. Accordingly, other implementations are within the scope that may be claimed.

1. A system of graphical user interfaces embodied on a non-transitory computer-readable medium and executable on processing circuitry, the system comprising:
an individual subscriber dashboard graphical user interface comprising
a summary control for displaying on an insured user's computing device and allowing interaction for presenting the insured user with summary information identifying current insurance plan coverage,
a compare control for displaying on the insured user's computing device and allowing interaction for presenting the insured user with comparison information comparing the current insurance plan coverage to one or more additional insurance plans, and
a contribution control for displaying on the insured user's computing device and allowing interaction for presenting the insured user with information identifying an employer payment portion of the current insurance plan premium and a remaining portion of the current insurance plan premium covered by the insured user;
an employer dashboard graphical user interface comprising
a summary control for displaying on an employer's computing device and allowing interaction for presenting the employer with summary information identifying insurance plan offerings extended to a plurality of employees of the employer,
a compare control for displaying on the employer's computing device and allowing interaction for presenting the employer with comparison information comparing the plan offerings extended to the plurality of employees to respective plan offerings extended by a plurality of other employers, and
a subsidy control for displaying on the employer's computing device and allowing interaction for presenting the employer with insurance subsidy information identifying insurance subsidies provided to the plurality of employees; and
a carrier dashboard graphical user interface comprising
an enrollment control for displaying on a carrier's computing device and allowing interaction for presenting the carrier with information identifying enrollment metrics of a plurality of subscribers of a plurality of insurance products provided by the carrier,
a ratings control for displaying on the carrier's computing device and allowing interaction for presenting the carrier with comparison information comparing at least one ratings metric corresponding to ratings submitted by a plurality of subscribers of the carrier to respective peer ratings metrics corresponding to ratings submitted by a plurality of other subscribers of a plurality of peer carriers, wherein the peer metrics and the at least one ratings metric are calculated in real time responsive to the interaction with the ratings control, and
a risk comparison control for displaying on the carrier's computing device and allowing interaction for presenting the carrier with comparison information comparing at least one average risk score to a respective average risk score of each peer of the plurality of peer carriers, wherein the at least one average risk score is calculated from respective risk scores of at least a portion of the plurality of subscribers of the carrier.

2. The system of claim 1, wherein the carrier dashboard graphical user interface further comprises a profit margin control configured, upon selection, to present the carrier with information regarding profits realized through subscriptions of the plurality of insurance products by the plurality of subscribers.

3. The system of claim 2, wherein the profit margin control is configured, upon selection to present the carrier with information regarding profit margins by insurance industry sector.

4. The system of claim 1, wherein the employer dashboard graphical user interface further comprises an upload control configured, upon selection, to establish a connection with the electronic medical record repository for accessing medical history information of at least one of the plurality of employees.

5. The system of claim 2, wherein the individual subscriber dashboard graphical user interface further comprises an upload control configured, upon selection, to establish a connection with an electronic medical record repository for accessing medical history information of the insured user.

6. The system of claim 1, further comprising an exchange dashboard graphical user interface, comprising:
an average risk score control configured, upon selection, to present an insurance exchange administrator with information regarding risk adjustments applied by a plurality of insurance carriers subscribed to an insurance exchange platform based upon a respective plurality of subscribers subscribing to products supplied to each carrier of the plurality of insurance carriers; and
a market data control configured, upon selection, to present analytical information regarding insurance products provided by the plurality of insurance carriers filtered by geographical region of the subscribers.

7. The system of claim 6, wherein the exchange dashboard graphical user interface further comprises a series of tabs each configured, upon selection, to navigate the exchange administrator to a presentation.

8. A system of graphical user interfaces for real-time display of data views including data compiled in real-time responsive to user selection, the system embodied as instructions on a non-transitory computer-readable medium and executable on processing circuitry, the system comprising:
an individual subscriber dashboard graphical user interface comprising
an upload control for displaying on an insured user's computing device and allowing interaction for providing a connection between an insurance exchange system and a third party electronic medical record repository,
a view all control for displaying on the insured user's computing device and allowing interaction for presenting the insured user with medical trend data representing changes over time in metrics of the insured user's electronic medical records, and
an authorization control for displaying on the insured user's computing device and allowing interaction for sharing the insured user's medical record data with an employer and a carrier, wherein the insured user is an employee of the employer and a subscriber of the carrier;
an employer dashboard graphical user interface comprising
a summary control for displaying on the employer's computing device and allowing interaction for presenting the employer with summary information identifying insurance plan offerings extended to a plurality of employees of the employer,
a compare control for displaying on the employer's computing device and allowing interaction for presenting the employer with comparison information comparing the plan offerings extended to the plurality of employees to respective plan offerings extended by a plurality of other employers, and
an upload medical histories control for displaying on the employer's computing device and allowing interaction for sharing the insured user's de-identified medical record data with the employer; and
a carrier dashboard graphical user interface comprising
an enrollment control for displaying on a carrier's computing device and allowing interaction for presenting the carrier with information identifying enrollment metrics of a plurality of subscribers of a plurality of insurance products provided by the carrier,
a risk comparison control for displaying on the carrier's computing device and allowing interaction for presenting the carrier with comparison information presenting at least one average risk score of the carrier and a respective average risk score of each peer of the plurality of peer carriers, wherein the at least one average risk score is representative of respective risk scores of at least a portion of the plurality of subscribers of the carrier;
wherein the instructions, when executed by the processing circuitry, cause the processing circuitry to
receive selection, from the insured user, of the upload control of the individual subscriber dashboard graphical user interface,
provide a connection between the system and a third party electronic medical record repository for authorization of the insured user,
upon authorization, access electronic medical records of the insured user,
access a user profile of the insured user,
populate, within the user profile using the electronic medical records, medical record data including prescription information, medical diagnoses, health conditions, and health metric data of the insured user,
after populating the medical record data,
receive selection, from the user, of the authorization control of the individual subscriber dashboard graphical user interface,
responsive to selection of the authorization control, execute a de-identification process of the user medical record data, and share the de-identified user medical record data with the carrier;
receive selection, from the user, of the view all control of the individual subscriber dashboard graphical user interface,
responsive to selection of the view all control, present, in real time, medical trend metrics derived from the user data,
receive selection, from the employer, of the upload medical histories control of the employer dashboard graphical user interface,
responsive to selection of the upload medical histories control, access the de-identified user medical record data,
after accessing the de-identified user medical record data, receive selection, from the employer, of the compare control of the employer dashboard graphical user interface,
responsive to selection of the compare control, present, to the employer within the employer dashboard graphical user interface, a comparison view presenting metrics derived from de-identified information of employees including the de-identified user medical record data and corresponding metrics of a plurality of additional employers participating in the system,
after receiving selection of the authorization control, receive selection, from the carrier, of the risk comparison control of the carrier dashboard graphical user interface, and
responsive to selection of the risk comparison control, present, to the carrier within the carrier dashboard graphical user interface, a comparison view presenting risk scores derived from de-identified information of subscribers including the de-identified user medical record data and corresponding risk scores of a plurality of additional carriers participating in the system.
